(19) United States
(12) Patent Application Publication
(10) Pub. No.: US 2026/0330648 A1
(43) Pub. Date: Oct. 22, 2026

(54) SYSTEMS AND METHODS FOR DYNAMICALLY AND ADAPTIVELY RESOLVING MOTION IN IMAGING

(71) Applicants: The Regents of the University of California, Oakland, CA (US); United States Government as represented by the Department of Veterans Affairs, Washington, DC (US)

(72) Inventors: Kim-Lien NGUYEN, Los Angeles, CA (US); Zhengyang MING, Los Angeles, CA (US); Dan RUAN, Los Angeles, CA (US); Anthony G. CHRISTODOULOU, Los Angeles, CA (US)

(73) Assignees: THE REGENTS OF THE UNIVERSITY OF CALIFORNIA, Oakland, CA (US); United States Government as represented by the Department of Veterans Affairs, Washingtion, DC (US)

(21) Appl. No.: 19/458,516

(22) Filed: Jan. 23, 2026

Related U.S. Application Data
(60) Provisional application No. 63/749,431, filed on Jan. 24, 2025.

(51) Int. Cl. G06T 7/20

(52) U.S. Cl. CPC G06T 7/20; G06T 2207/10081; G06T 2207/10088; G06T 2207/10104; G06T 2207/10132; G06T 2207/20076; G06T 2207/20212; G06T 2207/30028; G06T 2207/30044; G06T 2207/30048; G06T 2207/30061; G06T 2207/30092

(57) ABSTRACT

Systems and methods are disclosed for imaging motion (e.g., irregular and/or non-periodic motion) in a patient. A non-limiting exemplary method includes: receiving, by a processor via an imaging modality, image data and navigator data of a region of interest (ROI) of the patient over a predefined duration; determining, by the processor, via a clustering model using the navigator data, a cluster matrix of the ROI, wherein the cluster matrix of the ROI indicates, for each time frame in the predefined duration and for each of a plurality of clusters, a probability that a motion captured by the navigation data is associated with the cluster; and generating, by the processor, based on the cluster matrix of the ROI and the image data, reconstructed image data of the ROI over the predefined duration.

### RELATED APPLICATION

This application claims priority to U.S. Provisional Patent Application Ser. No. 63/749,431, filed on Jan. 24, 2025, which is incorporated herein by reference in its entirety for all purposes.

### STATEMENT REGARDING FEDERALLY SPONSORED RESEARCH OR DEVELOPMENT

This invention was made with government support under I01CX001901 awarded by the U.S. Department of Veterans Affairs, and HL148182, HL127153, and HL169695 awarded by the National Institutes of Health. The government has certain rights in the invention.

### BACKGROUND

Medical imaging has greatly advanced the understanding of the human body for diagnosis and treatment of medical conditions. However, various physiological processes, such as cardiac cycles, respiration, gastric motility, involve motion. Imaging these physiological processes involves capturing changes resulting from the motion as well as any periodicities to present a video and/or image data stream efficiently. Although conventional imaging techniques, such as cinematic magnetic resonance imaging (cine-MRI), can quantitatively evaluate motion-based processes such as cardiac morphology and function through averaging, conventional techniques fail to accurately and reliably capture motion that is irregular or non-periodic. Unfortunately, as various disease states are characterized by motion that is irregular or non-periodic, there is a desire and need for better imaging techniques to resolve, capture, and represent such motion. Conventional techniques for imaging such processes generate unwanted artifacts, fail to appropriately determine the irregular periodicities or adapt to them, and fail to capture details in the irregularities quickly enough to fully represent or capture the variation of the irregular motion.

For example, in complex arrhythmias such as atrial fibrillation, irregular beat-to-beat variation in cardiac motion can result in imaging artifacts and sometimes premature scan termination. Notably, atrial fibrillation has a prevalence of 1-2% in the United States and the estimated lifetime risk for atrial fibrillation is 1 in 3 for white and 1 in 4 for black individuals. The high incidence of atrial fibrillation and other disease states provide a strong desire and need for the development of techniques to manage highly irregular and non-periodic motion in MRI. In particular, there is a desire and need for a more flexible and data-driven method for accurately imaging the non-periodic nature of various bodily processes that maintains temporal continuity and image quality, while minimizing the presence of artifacts.

Various embodiments of the present disclosure address one or more of the above described shortcomings. The embodiments disclosed herein are generally directed towards imaging and more particularly directed towards systems, processes and methods for imaging that resolves motion.

### SUMMARY

Recognized herein is a need for imaging techniques capable of reconstructing images within a region of interest (ROI) that has motion, especially irregular and non-periodic motion, without reliance on periodic motion assumptions or external gating. The present disclosure describes computer-implemented methods, systems, and non-transitory computer-readable media that generate a probabilistic cluster matrix from navigator data acquired over a predefined duration and reconstruct motion-resolved images by weighting, combining, and temporally regularizing image data based on the cluster matrix.

Provided herein is a computer-implemented method of reconstructing images of a motion of a region of interest (ROI) of a subject, the method comprising: (a) receiving, by a processor via an imaging modality, image data and navigator data corresponding the motion of the ROI of the subject over a predefined duration; (b) determining, by the processor, a cluster matrix of the ROI using a clustering model applied the navigator data, wherein the cluster matrix of the ROI indicates, for each time frame within the predefined duration and for each cluster of a plurality of clusters, a probability that the motion captured by the navigation data is associated with a corresponding cluster; and (c) reconstructing, by the processor, the images of the motion of the ROI over the predefined duration by weighing and combining the image data based on the cluster matrix for the ROI.

In some embodiments, the ROI over the predefined duration can exhibit irregular and non-periodic motion. In some embodiments, the image data and the navigator data can be acquired by the imaging modality based on a golden step pulse sequence. In some embodiments, the determining the cluster matrix of the ROI comprises: (i) identifying the plurality of clusters based on the navigator data; and (ii) dynamically updating the plurality of clusters. In some embodiments, the dynamically updating the plurality of clusters can enforce temporal continuity between adjacent time frames. In some embodiments, the computer-implemented method of the present disclosure can further comprise, prior to the reconstructing: regularizing, by the processor, using the cluster matrix of the ROI, a similarity between at least two clusters of the plurality of clusters. In some embodiments, the regularizing the similarity can enforce similarity between adjacent clusters. In some embodiments, the computer-implemented method of the present disclosure can further comprise: determining a sensitivity map based on the image data, wherein the reconstructing is further based on the sensitivity map. In some embodiments, the reconstructing can comprise: applying a regularization along a temporal dimension of the image data using the cluster matrix of the ROI. In some embodiments, the regularization along the temporal dimension can comprise total variation regularization. In some embodiments, the image data can include one or more unresolved areas of the ROI, wherein the reconstructing can comprise: determining, using the cluster matrix of the ROI, an order and a weighting for each of the one or more unresolved areas of the ROI. In some embodiments, the receiving the image data and the navigator data can comprise: acquiring the image data from the subject via the imaging modality while the patient is freely breathing. In some embodiments, the cluster matrix can comprise non-binary values representing partial association with the plurality of clusters. In some embodiments, the image modality can comprise at least one of magnetic resonance imaging (MRI), computed tomography (CT), ultrasound, or positron emission tomography (PET). In some embodiments, the ROI can comprise cardiac tissue. In some embodiments, the imaging modality can be MRI, and wherein the navigator data can be acquired without reliance on electrocardiogram (ECG) gating. In some embodiments, the images of the motion of the ROI can be cardiac imaging, lung imaging, abdominal imaging, gastrointestinal (GI) imaging, fetal imaging, or oropharyngeal imaging.

Also provided herein is a system for reconstructing images of a motion of a ROI of a subject, the system comprising: a memory storing computer readable instructions, and one or more processors coupled to the memory and configured to perform operations comprising: (a) receiving, by the one or more processors via an imaging modality, image data and navigator data corresponding to the motion of the ROI of the subject over a predefined duration; (b) determining, by the one or more processors, a cluster matrix of the ROI using a clustering model applied to the navigator data, wherein the cluster matrix of the ROI indicates, for each time frame within the predefined duration and for each cluster of a plurality of clusters, a probability that the motion captured by the navigation data is associated with a corresponding cluster; and (c) reconstructing, by the one or more processors, the images of the motion of the ROI over the predefined duration by weighing and combining the image data based on the cluster matrix for the ROI.

In some embodiments, the ROI over the predefined duration can exhibit irregular and non-periodic motion. In some embodiments, the image data and the navigator data can be acquired by the imaging modality based on a golden step pulse sequence. In some embodiments, the determining the cluster matrix of the ROI can comprise: (i) identifying the plurality of clusters based on the navigator data; and (ii) dynamically updating the plurality of clusters. In some embodiments, the dynamically updating the plurality of clusters can enforce temporal continuity between adjacent time frames. In some embodiments, the system of the present disclosure can further comprise, prior to the reconstructing: regularizing, by the processor, using the cluster matrix of the ROI, a similarity between at least two clusters of the plurality of clusters. In some embodiments, the regularizing the similarity can enforce similarity between adjacent clusters. In some embodiments, the system of the present disclosure can further comprise: determining a sensitivity map based on the image data, wherein the reconstructing can further be based on the sensitivity map. In some embodiments, the reconstructing can comprise: applying a regularization along a temporal dimension of the image data using the cluster matrix of the ROI. In some embodiments, the regularization along the temporal dimension can comprise total variation regularization. In some embodiments, the image data can include one or more unresolved areas of the ROI, wherein the reconstructing can comprise: determining, using the cluster matrix of the ROI, an order and a weighting for each of the one or more unresolved areas of the ROI. In some embodiments, the receiving the image data and the navigator data can comprise: acquiring the image data from the subject via the imaging modality while the patient is freely breathing. In some embodiments, the cluster matrix can comprise non-binary values representing partial association with the plurality of clusters. In some embodiments, the image modality can comprise at least one of magnetic resonance imaging (MRI), computed tomography, ultrasound, or positron emission tomography. In some embodiments, the ROI can comprise cardiac tissue. In some embodiments, the imaging modality can be MRI, and wherein the navigator data can be acquired without reliance on electrocardiogram (ECG) gating. In some embodiments, the images of the motion of the ROI can be cardiac imaging, lung imaging, abdominal imaging, gastrointestinal (GI) imaging, fetal imaging, or oropharyngeal imaging.

Further provided herein is a non-transitory computer-readable medium storing instructions that, when executed by a processor, cause to perform operations comprising: (a) receiving, by the one or more processors via an imaging modality, image data and navigator data corresponding to a motion of a ROI of a subject over a predefined duration; (b) determining, by the one or more processors, a cluster matrix of the ROI using a clustering model applied to the navigator data, wherein the cluster matrix of the ROI indicates, for each time frame within the predefined duration and for each cluster of a plurality of clusters, a probability that the motion captured by the navigation data is associated with a corresponding cluster; and (c) reconstructing, by the one or more processors, the images of the motion of the ROI over the predefined duration by weighing and combining the image data based on the cluster matrix for the ROI.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

Like reference numbers and designations in the various drawings indicate like elements. For purposes of clarity, not every component may be labeled in every drawing.

The features of the present disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 is a schematic showing a non-limiting exemplary framework for dynamically and adaptively resolving motion in imaging, according to non-limiting exemplary embodiments of the present disclosure. In the data acquisition step (102), navigator data Yₙₐᵥ and image data Z_{img} were acquired using the sorted golden step pulse sequence. During cluster analysis (104), navigator data Yₙₐᵥ was separated from the image data Z_{img}. Navigator data Yₙₐᵥ served as the input into the clustering algorithm to generate cluster matrix M, which represented cardiac motion. Cluster matrix M describes the likelihood probability that motion from the navigator data at each time frame belongs to a specific cluster, which helped to resolve irregular motion. Regularization of the similarity between adjacent clusters and adjacent time frames was performed to get the final M. In the “time-resolved” reconstruction step (106), cluster matrix M was applied to order and weight the unsolved image in a pseudo-real-time formulation, and to mimic the nonperiodic motion pattern. Sensitivity maps in S were calculated based on the image data and the sampling operator Ω was defined based on the data acquisition pattern. To generate the final images, total variation regularization was applied along the temporal dimension.

FIG. 2 is a block diagram illustrating a computing device upon which embodiments of the present teachings can be implemented.

FIG. 3 is a block diagram illustrating an example computer-implemented method for dynamically and adaptively resolving motion in imaging, according to non-limiting embodiments of the present disclosure.

FIGS. 4A-4D collectively illustrate a comparison between k-means and DRACO for a patient with PVCs. ECG=electrocardiogram; PVC=premature ventricular contraction; DRACO=dynamic regularized adaptive clustering optimization.

FIG. 4A is a recorded ECG tracing belonging to a patient with predominantly sinus rhythm and a short period of non-sustained ventricular tachycardia (run of PVCs). Representative behavior of the cluster value matrix [symbol] , the binning results, and the cluster centroid matrix C are shown for k-means and DRACO.

FIG. 4B shows cluster value similarity matrices for k-means and DRACO.

FIG. 4C shows cluster binning results for k-means and DRACO.

FIG. 4D shows cluster centroid matrices for k-means and DRACO.

FIGS. 5A-5D collectively illustrate a comparison between k-means and DRACO for a patient with atrial fibrillation. ECG=electrocardiogram; DRACO=dynamic regularized adaptive clustering optimization. Representative behavior of the cluster value matrix [symbol] , the binning results, and the cluster centroid matrix C are shown for k-means and DRACO.

FIG. 5A is a recorded ECG tracing belonging to a patient with AF (time-varying RR intervals).

FIG. 5B shows cluster value similarity matrices for k-means (left) and DRACO (right).

FIG. 5C shows cluster binning results for k-means (left) and DRACO (right).

FIG. 5D shows cluster centroid matrices for k-means (left) and DRACO (right).

FIG. 6 shows self-correlation maps for subjects with sinus rhythm, PVCs, and AF. Recorded ECGs for sinus rhythm patient, PVCs, and AF (top row) and self-correlation maps of cluster matrices over time (bottom row) are shown. ECG=electrocardiogram; PVC=premature ventricular contraction.

FIG. 7 is a set of ventricular short axis images across several representative phases (left) and 1D profiles (right) across interventricular septum vs. time. The images and 1D profiles belong to a patient (age=68 years, average heart rate=60 BPM) who was in AF throughout the scan. Shown are basal (upper row) and mid (lower row) ventricular short axis images across seven of 25 frames reconstructed using k-means, k-means with “time resolved” TV (k-means+1 D TV), DRACO, and DRACO with “time resolved” TV (DRACO+1 D TV). The systolic and diastolic frames from the k-means received an image quality score of 2 while the frames from DRACO+1 D TV received a score of 3. The multiphase (cine) image quality score for DRACO+1 D TV was 4 for both the base and midventricular slice. The image quality score for k-means was 2 for both base and midventricular images. A movie file of the images is available at onlinelibrary.wiley.com/doi/10.1002/jmri.29425 (see VideoS1 in Supporting Information). BPM=beats per minute; TV=total variation; DRACO=dynamic regularized adaptive cluster optimization. Cine images from k-means, DRACO, and reference real-time reconstructions for FIG. 7. Shown are videos of basal and mid-ventricular short-axis images acquired at 3.0 T of a patient with atrial fibrillation.

FIGS. 8A-8B collectively illustrate a comparison of DRACO and reference real-time approaches for sinus rhythm and AF with low and high heart rates. DRACO=dynamic regularized adaptive cluster optimization; SAX=short axis; BPM=beats per minute, bSSFP=balanced steady-state free precession. A movie file the image is available at onlinelibrary.wiley.com/doi/10.1002/jmri.29425 (see VideoS2 in Supporting Information). Cine images from DRACO and the reference reconstructions for FIG. 8A. Shown are short-axis mid-ventricular videos of patients in sinus rhythm, low-heart-rate (average HR=45 BPM) atrial fibrillation, and high-heart-rate (average HR=95 BPM) atrial fibrillation. All data were acquired at 3.0 T and reconstructed using the proposed DRACO method and the corresponding reference method (sinus rhythm volunteer: ECG-gated segmented bSSFP sequence, atrial fibrillation patients: real-time sequence).

FIG. 8A shows systolic and diastolic images belonging to patients with sinus rhythm and AF with low heart rate (average ~45 BPM) and high heart rate (average ~95 BPM). Images for DRACO were acquired with the sorted golden-step sequence and reconstructed using the DRACO algorithm and time resolved reconstruction. Reference images were acquired using the reference real-time bSSFP sequence with inline reconstruction.

FIG. 8B is a set of corresponding recorded ECG signals in subjects with sinus rhythm, low-heart-rate AF, and high-heart-rate AF. Shown is the simultaneously recorded ECG signal with corresponding data points that were clustered for the corresponding systolic and diastolic phases. The R peaks are marked by the gray arrowheads. Points chosen by the DRACO method are depicted in blue and red. In general, blue points are binned into the systolic cluster while red points are binned into the diastolic cluster. The time duration for the systolic and diastolic periods is marked by the blue and red rectangles, respectively.

FIG. 9 is a plot of the relationship between the preceding RR interval and the temporal left ventricular area change. Data points from the mid ventricular short-acis images of 11 patients with atrial fibrillation. Two patients with atrial fibrillation who received contrast injection were excluded. The correlation coefficient between left ventricular area change and preceding RR interval was 0.647. Two patients with contrast agent injection were excluded. Each color represents a unique patient.

FIGS. 10A-10B show Bland-Altman plots comparing left ventricular and right ventricular metrics of cardiac function. The metrics were assessed using the proposed DRACO method and reference real-time pulse sequence. The dotted horizontal lines represent the 95% limit of agreement. LV=left ventricle; RV=right ventricle.

FIG. 10A is a set of Bland-Altman plots of left ventricular ejection fraction, end-systolic volume, and end-diastolic volume.

FIG. 10B is a set of Bland-Altman plots of right ventricular ejection fraction, end-systolic volume, and end-diastolic volume.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DETAILED DESCRIPTION

The present disclosure describes computer-implemented methods, systems, and non-transitory computer-readable media that reconstruct motion-resolved images by probabilistically modeling motion using navigator data acquired over a predefined duration. In some embodiments, a clustering model can generate a dynamically updated cluster matrix that represents, for each time frame, a probability of association with a plurality of motion clusters corresponding to distinct motion states of the region of interest. Using the cluster matrix, image data can be weighted, combined, and temporally regularized to reconstruct images that preserve motion continuity while reducing artifacts caused by irregular or non-periodic motion. In some embodiments, regularization can enforce similarity between adjacent motion clusters and temporal continuity across time frames, enabling improved temporal coherence without discarding acquired data or requiring external gating signals. The disclosed techniques can be applied across multiple imaging modalities and can be particularly advantageous for imaging physiological motion, including cardiac motion, respiratory motion, or other complex motion patterns that vary over time. The resulting framework can provide robust motion-aware image reconstruction suitable for both qualitative visualization and quantitative analysis.

The embodiments of the present disclosure are described in greater details below. This specification describe various exemplary embodiments of systems, software and methods for dynamically and adaptively resolving motion in imaging, including resolving motion that is irregular or non-periodic. The disclosure, however, is not limited to these exemplary embodiments and applications or to the manner in which the exemplary embodiments and applications operate or are described herein.

The following descriptions and examples illustrate embodiments of the present disclosure in detail. Although the present disclosure has been described in some details by way of illustration and example for purposes of clarity and understanding, it will be apparent that certain changes and modifications can be practiced within the scope of the appended claims.

The section headings used herein are for organizational purposes only and are not to be construed as limiting the subject matter described.

Although various features of the disclosure can be described in the context of a single embodiment, the features can also be provided separately or in any suitable combination. Conversely, although the present disclosure can be described herein in the context of separate embodiments for clarity, the present disclosure can also be implemented in a single embodiment. It is to be understood that the present disclosure is not limited to the particular embodiments described herein and as such can vary. Those of skill in the art will recognize that there are variations and modifications of the present disclosure, which are encompassed within its scope.

It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All patent filings, websites, other publications, accession numbers and the like cited above or below are incorporated by reference in their entirety for all purposes to the same extent as if each individual item were specifically and individually indicated to be so incorporated by reference. If different versions of a sequence are associated with an accession number at different times, the version associated with the accession number at the effective filing date of this application is meant. The effective filing date means the earlier of the actual filing date or filing date of a priority application referring to the accession number if applicable. Likewise, if different versions of a publication, website or the like are published at different times, the version most recently published at the effective filing date of the application is meant unless otherwise indicated. Any feature, step, element, embodiment, or aspect of the disclosure can be used in combination with any other unless specifically indicated otherwise.

### I. Definition

All terms are intended to be understood as they would be understood by a person skilled in the art. Unless defined otherwise, all technical and scientific terms used herein have the same meaning as commonly understood by one of ordinary skill in the art to which the disclosure pertains.

It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Headings, e.g., I, II, III, or A, B, C etc., are presented merely for ease of reading the specification and claims. The use of headings in the specification or claims does not require the steps or elements be performed in alphabetical or numerical order or the order in which they are presented.

The singular form “a”, “an”, and “the” include plural references unless the context clearly dictates otherwise. For example, the term “a cell” includes one or more cells, including mixtures thereof.

“A and/or B” is used herein to include all of the following alternatives: “A”, “B”, “A or B”, and “A and B”.

The term “about” or “approximately” means within an acceptable error range for the particular value as determined by one of ordinary skill in the art, which will depend in part on how the value is measured or determined, i.e., the limitations of the measurement system. Where particular values are described in the application and claims, unless otherwise stated the term “about” meaning within an acceptable error range for the particular value should be assumed.

It is understood that aspects and embodiments of the disclosure described herein include “comprising,” “consisting,” and “consisting essentially of” aspects and embodiments. As used herein, “comprising” is synonymous with “including”, “containing”, or “characterized by”, and is inclusive or open-ended and does not exclude additional, unrecited elements or method steps. As used herein, “consisting of” excludes any elements, steps, or ingredients not specified in the claimed composition or method. As used herein, “consisting essentially of” does not exclude materials or steps that do not materially affect the basic and novel characteristics of the claimed composition or method. Any recitation herein of the term “comprising”, particularly in a description of components of a composition or in a description of steps of a method, is understood to encompass those compositions and methods consisting essentially of and consisting of the recited components or steps.

As used herein, the term “imaging modality” refers to a system, device, or technique configured to acquire data that can be processed to generate images of a region of interest of a subject. The imaging modality can generate image data, navigator data, or both, and can support acquisition of spatially and temporally resolved information. In some embodiments, the imaging modality can comprise a medical imaging system that acquires data based on physical interactions between the subject and one or more forms of energy, such as, but not limited to, electromagnetic energy, acoustic energy, radioactive emissions, or combinations thereof. The imaging modality can include hardware components, control circuitry, and acquisition sequences or protocols used to collect imaging data. Non-limiting exemplary imaging modality includes, but not limited to, magnetic resonance imaging (MRI), computed tomography (CT), ultrasound imaging, positron emission tomography (PET), or combinations thereof. In some embodiments, the imaging modality can further include hybrid systems or multi-modal systems that integrate two or more imaging techniques. In some embodiments, the imaging modality can acquire data continuously or intermittently over a predefined duration and can support free-running acquisition without reliance on external gating signals. In some embodiments, the imaging modality can be configured to acquire image data concurrently with navigator data or other motion-sensitive data. In some embodiments, the imaging modality can include associated acquisition parameters, pulse sequences, sampling patterns, or control signals that govern how data is acquired. In some embodiments, the imaging modality can further include interfaces for transferring acquired data to one or more processors for clustering, reconstruction, or analysis as described herein.

As used herein, the term “image data” refers to data acquired by an imaging modality that contains spatial information corresponding to a region of interest of a subject and that can be used, directly or indirectly, to generate one or more images. Image data can include measurements obtained during an image acquisition process and can represent spatially encoded signals, samples, or values associated with the region of interest. In some embodiments, image data can be acquired in a spatial domain, a frequency domain, a transform domain, or combinations thereof. For example, image data can comprise k-space data, projection data, raw sensor data, or other encoded measurements that can be transformed, reconstructed, or processed to form images. In some embodiments, image data can be acquired over a predefined duration and can correspond to multiple time frames. The image data can reflect motion of the region of interest over time and can include data acquired at different time points, under different motion states, or with different sampling patterns. In some embodiments, image data can be acquired concurrently with navigator data or other motion-sensitive data. The image data can be separated from the navigator data for processing or can be processed jointly with the navigator data during reconstruction. In some embodiments, image data can include under-sampled, incomplete, or unresolved portions of the region of interest. Such image data can be processed using reconstruction techniques that incorporate motion information, sensitivity maps, sampling operators, regularization, or combinations thereof. In some embodiments, image data can be modality-specific and can be acquired using magnetic resonance imaging, computed tomography, ultrasound imaging, positron emission tomography, or other imaging modalities.

As used herein, the term “navigator data” refers to data acquired by an imaging modality that encodes information indicative of motion, position, or temporal variation of a region of interest, and that can be used to characterize motion occurring during image acquisition. Navigator data can be acquired for the purpose of motion characterization rather than direct image formation. In some embodiments, navigator data can comprise low-spatial-frequency data, projection data, k-space center lines, or other motion-sensitive measurements that reflect changes in the region of interest over time. The navigator data can be acquired intermittently or continuously during image acquisition and can be temporally associated with corresponding image data. In some embodiments, navigator data can be acquired concurrently with image data using the same imaging modality and pulse sequence. The navigator data can be interleaved with image data acquisition or embedded within the acquisition sequence without interrupting image acquisition. In some embodiments, navigator data can be processed to extract motion-related features, including displacement, deformation, temporal variation, or other motion characteristics of the region of interest. Such processed navigator data can be used as input to a clustering model, motion estimation process, or other analysis technique. In some embodiments, navigator data can be separated from image data prior to reconstruction and used to generate motion representations, including a cluster matrix or other motion descriptors. The navigator data can guide reconstruction by informing how image data acquired at different time frames or under different motion states can be weighted, combined, or ordered. In some embodiments, navigator data can be modality-specific and can be acquired using magnetic resonance imaging, computed tomography, ultrasound imaging, positron emission tomography, or other imaging modalities.

As used herein, the term “region of interest” (ROI) refers to a selected portion of a subject, image, or imaging volume for which image data and motion information are acquired, analyzed, or reconstructed. The ROI can define a spatial region that contains anatomical structures, tissue, or other features relevant to a particular imaging or analysis task. In some embodiments, the ROI can correspond to a two-dimensional region, a three-dimensional volume, or a time-varying spatial region. In some embodiments, the ROI can be fixed in space or can change over time to reflect motion of the subject or anatomical structures within the subject. In some embodiments, the ROI can be selected prior to image acquisition, during image acquisition, or during post-processing. In some embodiments, the ROI can be defined manually, automatically, or semi-automatically based on anatomical landmarks, image content, motion characteristics, or other criteria. In some embodiments, the ROI can comprise one or more anatomical structures, including cardiac tissue, lung tissue, abdominal organs, gastrointestinal tissue, fetal anatomy, musculoskeletal structures, or combinations thereof. In some embodiments, the ROI can include tissue undergoing motion that is periodic, irregular, non-periodic, or time-varying. In some embodiments, the ROI can correspond to a subset of a larger imaging field of view. Image data and navigator data associated with the ROI can be extracted from a larger dataset and processed independently or in combination with data associated with other regions. In some embodiments, the ROI can be used to guide acquisition, motion characterization, clustering, reconstruction, or analysis of image data, including determining motion states, generating a cluster matrix, or reconstructing images over a predefined duration.

As used herein, the term “cluster matrix” refers to a data structure that represents associations between acquired data and a plurality of clusters corresponding to motion states or other data groupings over time. In some embodiments, the cluster matrix can encode, for each time frame within a predefined duration and for each cluster of a plurality of clusters, a value indicating an extent to which data acquired at that time frame associates with the corresponding cluster. In some embodiments, the cluster matrix can comprise non-binary values that represent partial or probabilistic association with multiple clusters. The values can be constrained such that, for a given time frame, associations across the plurality of clusters satisfy one or more normalization conditions, including summing to a constant or representing a probability distribution. In some embodiments, the cluster matrix can be generated using a clustering model applied to navigator data or other motion-sensitive data. The clustering model can identify clusters corresponding to distinct motion states and can assign association values that reflect similarity between acquired data and cluster characteristics. In some embodiments, the cluster matrix can be updated dynamically as additional data becomes available. Dynamic updating can allow the cluster matrix to adapt to changes in motion patterns over the predefined duration. Regularization can be applied to the cluster matrix to enforce temporal continuity between adjacent time frames or similarity between adjacent clusters. In some embodiments, the cluster matrix can be used during image reconstruction to weight, combine, order, or otherwise modulate contributions of acquired data. The cluster matrix can guide how data acquired at different time frames contribute to reconstructed images associated with particular motion states or time points. In some embodiments, the cluster matrix can have dimensions corresponding to a number of clusters and a number of time frames. Each column or row of the cluster matrix can represent associations for a particular time frame or cluster, respectively.

As used herein, the term “golden step pulse sequence” refers to an imaging pulse sequence that acquires data using a sampling strategy in which successive acquisitions advance sampling locations by a predetermined incremental step selected to promote uniform or near-uniform coverage of a sampling domain over time. The predetermined incremental step can be chosen such that sampling locations do not repeat periodically and can remain well distributed across the sampling domain as acquisition progresses. In some embodiments, the golden step pulse sequence can apply the predetermined incremental step between successive sampling events in a spatial, frequency, phase-encoding, or k-space domain. The incremental step can be derived from a golden ratio-based relationship, an irrational increment, or another non-repeating increment that reduces coherent repetition of sampling locations. In some embodiments, the golden step pulse sequence can acquire data in a free-running manner over a predefined duration, without reliance on external gating signals or predefined motion cycles. Because the sampling locations can remain well distributed for arbitrary subsets of acquired data, data acquired using the golden step pulse sequence can remain suitable for retrospective grouping, weighting, or reordering based on motion information. In some embodiments, the golden step pulse sequence can acquire image data and navigator data concurrently. The navigator data can include motion-sensitive measurements, such as k-space center lines, projections, or low-spatial-frequency components, that reflect motion of a region of interest over time. The golden step pulse sequence can therefore support motion characterization and subsequent reconstruction without interrupting image acquisition. In some embodiments, the golden step pulse sequence can be implemented using Cartesian sampling, radial sampling, spiral sampling, or combinations thereof. The predetermined incremental step can be applied along one or more encoding directions, and additional sampling events can be interleaved with navigator acquisitions as described herein.

As used herein, the term “regularization”, “regularizing”, or any grammatical variant thereof refers to one or more constraints, penalty terms, or modifying operations applied during processing, optimization, or reconstruction to influence a solution toward desired characteristics. Regularization can be used to stabilize processing, reduce sensitivity to noise or undersampling, or promote consistency across data dimensions. In some embodiments, regularization can be applied during determination of a cluster matrix, during image reconstruction, or during both. Regularization can influence associations between data and clusters, evolution of motion states over time, or properties of reconstructed images. In some embodiments, regularization can enforce temporal continuity between adjacent time frames, similarity between adjacent clusters, smooth transitions between motion states, or combinations thereof. In some embodiments, regularization can operate along a temporal dimension, a spatial dimension, a cluster dimension, or combinations thereof. In some embodiments, regularization can comprise total variation regularization, smoothness constraints, sparsity-promoting constraints, or other forms of constraint that guide processing while allowing data fidelity to be maintained. In some embodiments, regularization can be implemented using one or more weighting parameters that balance the influence of regularization relative to data fidelity. In some embodiments, regularization can be incorporated into an objective function, cost function, or iterative update rule used to estimate clustering assignments, cluster centroids, reconstructed images, or other quantities. Regularization can therefore shape a solution space without prescribing a single deterministic outcome.

As used herein, the term “sensitivity map” refers to spatially varying information that characterizes how an imaging system receives, detects, or measures signals from different spatial locations within a region of interest. In some embodiments, the sensitivity map can represent relative signal reception characteristics across space and can be used during image reconstruction to account for nonuniform signal detection. In some embodiments, the sensitivity map can be determined from acquired image data, calibration data, or a combination thereof. The sensitivity map can be estimated using one or more calibration or self-calibration techniques and can reflect spatial variations arising from hardware configuration, detector geometry, or acquisition conditions. In some embodiments, the sensitivity map can be incorporated into a reconstruction process to relate acquired data to reconstructed images. For example, the sensitivity map can be used to weight, scale, or otherwise modulate contributions of acquired data during reconstruction such that spatial variations in signal reception are compensated. In some embodiments, the sensitivity map can comprise complex valued information, magnitude-only information, phase information, or combinations thereof. The sensitivity map can be defined for one or more receive elements, detectors, channels, or sensors of the imaging modality. In some embodiments, the sensitivity map can be static over the predefined duration or can be updated dynamically based on the image data. The sensitivity map can be applied independently or in combination with other reconstruction components, including sampling operators, motion clustering information, or temporal regularization.

As used herein, the term “subject” refers to an entity from which image data and navigator data are acquired by an imaging modality. The subject can comprise a living organism, a portion of a living organism, or a non-living object that undergoes motion during imaging. In some embodiments, the subject can comprise a human, an animal, or a portion thereof. In some embodiments, the subject can comprise a patient undergoing medical imaging, including diagnostic or monitoring imaging. The subject can include anatomical structures, tissues, or organs that exhibit motion that is periodic, irregular, non-periodic, or time-varying. In some embodiments, the subject can comprise a non-human organism or an experimental model used for research or development purposes. In some embodiments, the subject can comprise a physical phantom, test object, or simulated structure configured to mimic motion characteristics of biological tissue. In some embodiments, the subject can undergo voluntary or involuntary motion, physiological motion, externally induced motion, or combinations thereof during image acquisition. The subject can be imaged while freely breathing, moving, or remaining stationary, depending on the imaging context.

It is appreciated that certain features of the disclosure, which are, for clarity, described in the context of separate embodiments, can also be provided in combination in a single embodiment. Conversely, various features of the disclosure, which are, for brevity, described in the context of a single embodiment, can also be provided separately or in any suitable sub-combination. All combinations of the embodiments pertaining to the disclosure are specifically embraced by the present disclosure and are disclosed herein just as if each and every combination was individually and explicitly disclosed. In addition, all sub-combinations of the various embodiments and elements thereof are also specifically embraced by the present disclosure and are disclosed herein just as if each and every such sub combination was individually and explicitly disclosed herein.

### II. Overview

Cine MRI is the reference standard for quantitative evaluation of cardiac morphology and function. In settings of complex arrhythmias such as atrial fibrillation (AF), irregular cardiac motion can result in imaging artifacts and sometimes premature scan termination. Notably, AF has a prevalence of 1-2% in the United States and the estimated lifetime risk for AF is 1 in 3 for white and 1 in 4 for black individuals. The high incidence of AF provides strong motivation for the development of techniques to manage highly irregular and nonperiodic cardiac motion in quantitative MRI. Although self-gating methods have been developed to relieve the dependency on electrocardiogram (ECG)-gating, typical self-gating methods often assume periodic or quasiperiodic cardiac motion or that cardiac motion is within a specified frequency range. These assumptions often fail when capturing irregular cardiac motion for quantitative assessment.

In complex arrhythmias, the nonperiodic nature of cardiac motion demands more flexible data-driven methods, and clustering algorithms represent one possible solution. In general, clustering approaches partition data into multiple groups, and drive group association based on definitions of similarity between the data points. Although clustering algorithms have been used in cardiac MRI postprocessing including segmentation and automatic disease detection, they are rarely used in the processing of raw image data and subsequent reconstruction steps. For handling of cardiac motion, k-means has been applied in several MRI approaches including ECG-free 2D cine MRI for quantitative evaluation of cardiac function in sinus rhythm. However, this method has limitations in some patients with AF, specifically flickering artifacts and unstable image quality across different phases, which can be attributed to temporal inconsistencies. Another limitation, intrinsic to k-means clustering, is arbitrary indexing, which does not provide any specific temporal ordering to reflect cardiac phase relationships. The temporal continuity of cardiac motion is therefore neither fully leveraged nor represented when a simple k-means approach is used.

The present disclosure describes a method called dynamic regularized adaptive cluster optimization (DRACO) which generates cine images that can be used for quantitative evaluation of cardiac morphology and function. The present disclosure was developed to cope with complex arrhythmias and with the hypotheses that (1) cluster indexing of cardiac motion binning should be continuous along the natural time dimension and (2) the centroids of temporally adjacent clusters should be close in the image or projection dimension. The present disclosure evaluates the performance of the proposed DRACO imaging framework relative to k-means clustering for handling complex arrhythmias in cardiac cine MRI using a sorted golden step pulse sequence.

Conventional real-time MRI techniques can reconstruct images sequentially using temporally adjacent image acquisition data. In such techniques, image frames can be generated directly as data is acquired, without retrospective organization of motion states. This approach can rely primarily on temporal proximity rather than explicit modeling of motion, and can treat motion variability as noise within the reconstruction process. As a result, when motion within a region of interest (ROI) exhibits irregular, non-periodic, or time-varying characteristics, conventional real-time imaging can produce image sequences that exhibit reduced signal-to-noise ratio, temporal inconsistency, or flickering artifacts. In some embodiments, conventional real-time techniques can require increased temporal sampling or reduced spatial resolution in order to maintain apparent temporal continuity.

In contrast, the method of the present disclosure can explicitly model motion within a region of interest (ROI) prior to image reconstruction. Rather than reconstructing image frames solely based on temporal adjacency, DRACO can determine a probabilistic cluster matrix that represents associations between acquired data and a plurality of motion states over time. In some embodiments, each time frame can be associated with multiple clusters using non-binary values, allowing partial membership across motion states. This probabilistic representation can enable the reconstruction process to account for irregular or non-periodic motion without discarding acquired data or enforcing rigid temporal bins.

Conventional real-time imaging techniques can lack mechanisms for enforcing consistency between adjacent motion states, which can result in abrupt transitions between reconstructed frames when motion patterns vary. DRACO, in contrast, can apply regularization that enforces similarity between clusters and temporal continuity across time frames. In some embodiments, such regularization can suppress abrupt frame-to-frame changes while preserving physiologically meaningful motion. As a result, DRACO can generate reconstructed image data that exhibits improved temporal coherence relative to conventional real-time techniques.

Additionally, conventional real-time imaging can reconstruct each image frame independently or with limited temporal context, which can limit the ability to leverage information acquired across multiple motion cycles. DRACO can instead weight and combine image acquisition data across time using the cluster matrix, thereby enabling reconstruction that incorporates data from multiple motion occurrences that share similar motion characteristics. In some embodiments, this approach can improve image quality while reducing the number of reconstructed frames required for quantitative analysis.

While conventional real-time imaging techniques can prioritize immediacy of reconstruction, the DRACO technique can prioritize motion-aware reconstruction through probabilistic clustering and regularization. This distinction can allow DRACO to accommodate complex, irregular, or non-periodic motion within a region of interest (ROI) in ways that conventional real-time imaging techniques cannot achieve.

### III. Dynamic Regularized Adaptive Cluster Optimization (DRACO)

As discussed, imaging various physiological processes, such as cardiac cycles and respiration, involves imaging motion and capturing details and patterns within the motion. Although conventional imaging techniques, such as cinematic magnetic resonance imaging (cine-MRI), can quantitatively evaluate motion-based processes such as cardiac morphology and function, conventional techniques fail to accurately and reliably capture motion that is irregular or nonperiodic. Unfortunately, as various diseases are characterized by motion that is irregular or non-periodic, there is a desire and need for better imaging techniques to resolve such motion.

For example, for complex arrhythmias such as atrial fibrillation, irregular cardiac motion can result in imaging artifacts and sometimes premature scan termination. Notably, atrial fibrillation has a prevalence of 1-2% in the United States and the estimated lifetime risk for atrial fibrillation is 1 in 3 for white and 1 in 4 for black individuals.

Conventional techniques for imaging such processes either fail to appropriately determine the irregular periodicities and dynamically adapt to them, fail to reduce artifacts that result from motion-based imaging, or fail to capture details in the irregularities quickly enough. For example, although gating methods (e.g., electrocardiogram (ECG)-gating) has been proposed as one approach to reducing artifacts in motion-based imaging, conventional gating methods often assume periodic or quasiperiodic physiological motion or assume that the motion is within a specified frequency range. These assumptions often fail when capturing irregular physiological motion for quantitative assessment.

Clustering models, which partition image data into groups and drive group association based on definitions of similarity between the data points of the image data, may potentially image non-periodic physiological processes. However, there are many limitations hindering the use of clustering models in the processing of raw image data and subsequent reconstruction steps. For example, clustering models such as k-means for modeling non-periodic physiological processes such as atrial fibrillation have resulted in images with flickering artifacts and unstable image quality across different phases, which was attributed to temporal inconsistencies. Another limitation intrinsic to k-means clustering is arbitrary indexing, which does not provide any specific temporal ordering to reflect cardiac phase relationships. The temporal continuity of cardiac motion is therefore neither fully leveraged nor represented, even when a simple k-means approach is used.

The high incidence of atrial fibrillation and other disease states involving irregular and non-periodic motion provides a strong desire and need for the development of techniques to efficiently image highly irregular and non-periodic motion. In particular, there is a desire and need for a more flexible and data-driven method for accurately imaging the non-periodic nature of various physiological processes that maintains temporal continuity and image quality, while minimizing the presence of artifacts.

The present disclosure thus describes a novel and nonobvious solution to the aforementioned shortcomings by describing systems, processes and methods for dynamically and adaptively resolving motions, including irregular and non-periodic motions, in imaging. Such imaging techniques can be used to generate cine images (e.g., via reconstructed image data) that can be used for the quantitative evaluation of various organ morphology and physiological functions. In various embodiments, such imaging techniques involve receiving acquired image data (e.g., raw image data and/or transformed k-space data) and navigator data (e.g., image acquisition data sampled across time points) across a predefined time period to identify or determine a plurality of clusters. The techniques further involve generating a cluster matrix indicating probabilities of k-space samples (e.g., motion state probabilities) captured by the navigation data being associated with each of the plurality of clusters. The cluster matrix of probabilities allows the association between the k-space samples and clusters to be relatively more relaxed in order to depict a smoother transition between dynamic motion states, regardless of the periodicity or non-periodicity of the physiological process. The relaxed association based on the probabilistic matrix can also enable iterative adaptation, for example, as new clusters are identified or as new dynamic motion states (e.g., phases of cardiac motion) are determined. Furthermore, the cluster matrix can ensure that the cluster indexing of physiological motion binning is continuous along a natural time dimension. Even further, the cluster matrix can ensure that centroids of temporally adjacent clusters are close in the image or projection dimension. In some embodiments, regularization can be imposed on the plurality of clusters to provide a flexible mechanism for integration of varying physiological motion patterns and sequential temporal ordering. A reconstructed image depicting the physiological process can then be generated using the cluster matrix and the image acquisitions data.

The present disclosure finds that the aforementioned optimization-driven adaptive techniques can singularly resolve both periodic and non-periodic physiological motion patterns. The present disclosure also finds that the dynamic and adaptive imaging techniques described herein performed better than k-means clustering in handling complex arrhythmias in cardiac cine MRI using a sorted golden step pulse sequence, and can also be suitable for other physiological processes involving irregular motion.

A. Image Reconstruction using Navigator-Derived Motion Clustering

Imaging of a region of interest (ROI) undergoing motion can present technical challenges when the motion exhibits irregular, non-periodic, or time-varying characteristics. Conventional reconstruction techniques can rely on temporal adjacency of image data or on assumptions of periodic motion, which can lead to temporal inconsistency or motion-induced artifacts when such assumptions do not hold. The techniques described herein can address these challenges by reconstructing images based on motion information derived from navigator data rather than relying solely on acquisition timing.

In accordance with the present disclosure, image reconstruction can proceed by receiving image data and navigator data corresponding to motion of a ROI over a predefined duration. The navigator data can capture temporal variations associated with motion of the ROI and can serve as input to a clustering model. In some embodiments, the clustering model can represent motion as a plurality of clusters corresponding to distinct motion states of the region of interest.

Using the clustering model, a cluster matrix of the ROI can be determined. The cluster matrix can indicate, for each time frame within the predefined duration and for each cluster of the plurality of clusters, a probability that motion captured by the navigator data associates with the corresponding cluster. In some embodiments, the cluster matrix can comprise non-binary values that allow partial association with multiple clusters at a given time frame, thereby providing a continuous and time-resolved representation of motion.

Based on the cluster matrix, images of the motion of the ROI can be reconstructed by weighting and combining the image data according to the probabilistic associations represented in the cluster matrix. In some embodiments, image data acquired at different time frames that correspond to similar motion states can be coherently combined, while image data associated with differing motion states can be weighted to preserve motion continuity across reconstructed images.

In some embodiments, reconstruction can further include applying regularization using the cluster matrix to enforce temporal continuity or similarity between clusters. Such regularization can suppress abrupt transitions between reconstructed images and can reduce artifacts associated with irregular or non-periodic motion. In some embodiments, reconstruction can include applying regularization along a temporal dimension of the image data, including total variation regularization, to further improve temporal coherence of the reconstructed images.

### B. Data Acquisition and Motion Navigation

Image reconstruction as described herein can proceed by receiving image data and navigator data corresponding to motion of a ROI of a subject over a predefined duration. The image data can represent spatial information of the ROI, while the navigator data can capture temporal variations associated with motion of the ROI. By acquiring both image data and navigator data over the predefined duration, the disclosed techniques can enable characterization of motion that can support subsequent clustering and reconstruction.

In some embodiments, the image data and the navigator data can be acquired by an imaging modality operating in a continuous or free-running acquisition mode. Such acquisition can allow data collection to proceed without reliance on external gating signals or assumptions of periodic motion. As a result, motion of the ROI that varies in timing, amplitude, or duration can be captured directly in the acquired navigator data rather than excluded or averaged during acquisition.

The navigator data can be derived from motion sensitive components of the acquired imaging data. In some embodiments, the navigator data can comprise k-space center line data, projection data, low-spatial-frequency data, or combinations thereof that can exhibit sensitivity to motion of the ROI. The navigator data can provide a temporally resolved representation of motion while remaining temporally aligned with the image data used for reconstruction.

In some embodiments, the image data and the navigator data can be acquired using a sampling pattern that promotes favorable distribution of acquired data over time, including a golden step pulse sequence. By advancing a sampling pattern according to a golden step, subsets of the acquired image data can maintain relatively uniform coverage regardless of how the data is subsequently weighted, combined, or reordered based on motion. This acquisition approach can facilitate flexible reconstruction when motion of the ROI exhibits irregular or non-periodic behavior.

A golden step can refer to a predetermined incremental change applied to a sampling position between successive acquisitions, wherein the incremental change can promote uniform coverage of a sampling domain over time. By applying a golden step between acquisitions, the sampling locations can avoid repeating the same pattern in a periodic manner, thereby distributing acquired data more evenly across the predefined duration.

In some embodiments, the golden step can correspond to an increment derived from a golden ratio based relationship or another irrational increment that reduces coherent repetition of sampling positions. Use of such an increment can allow subsets of acquired data, selected retrospectively or based on motion characteristics, to maintain favorable distribution properties. As a result, image data can remain suitable for reconstruction even when acquisition timing varies or when data is regrouped based on motion of a region of interest.

A golden step pulse sequence can refer to an imaging pulse sequence that incorporates the golden step sampling strategy during data acquisition. In some embodiments, the golden step pulse sequence can acquire image data continuously over the predefined duration while advancing sampling locations according to the golden step. This approach can allow image data to be acquired in a free running manner without reliance on external gating signals or assumptions of periodic motion.

In some embodiments, the golden step pulse sequence can further acquire navigator data concurrently with the image data. The navigator data can comprise motion sensitive signals, including center line data, projection data, or low spatial frequency components, that reflect motion of the region of interest over time. Because the golden step pulse sequence can distribute sampling locations uniformly over time, the navigator data can remain temporally aligned with the image data and suitable for motion characterization across irregular or non-periodic motion patterns. In some embodiments, this acquisition strategy can enable reconstruction of images of a region of interest undergoing irregular and non-periodic motion without discarding acquired data or enforcing rigid temporal segmentation.

The navigator data acquired over the predefined duration can reflect one or more types of motion of the ROI. In some embodiments, the motion can comprise physiological motion, including cardiac motion, respiratory motion, gastrointestinal motion, or combinations thereof. Because the navigator data can be acquired concurrently with the image data, the motion information can remain temporally consistent with the spatial information used during reconstruction.

### C. Probabilistic Motion Clustering and Cluster Matrix Generation

Using the navigator data acquired over the predefined duration, the disclosed techniques can determine a cluster matrix of a region of interest (ROI) using a clustering model applied to the navigator data. The clustering model can operate on motion-related features extracted from the navigator data and can represent motion of the ROI as a plurality of clusters corresponding to distinct motion states. In some embodiments, the clustering model can operate without assuming periodicity of motion or uniform timing between motion events.

In some embodiments, determining the cluster matrix can include identifying the plurality of clusters based on similarities in the navigator data across time frames. The similarities can reflect motion characteristics of the ROI, including displacement, deformation, or other motion-related variations captured in the navigator data. The clustering model can group navigator data associated with similar motion characteristics into clusters while allowing differences between clusters to reflect distinct motion states.

Unlike hard clustering approaches that assign each time frame exclusively to a single cluster, the clustering model described herein can generate a probabilistic association between time frames and clusters. In some embodiments, the cluster matrix can indicate, for each time frame within the predefined duration and for each cluster of the plurality of clusters, a probability that motion captured by the navigator data associates with the corresponding cluster. The cluster matrix can therefore comprise non-binary values that allow partial association with multiple clusters at a given time frame.

In some embodiments, the clustering model can dynamically update the plurality of clusters over time. Dynamic updating can allow the clustering model to adapt to changes in motion patterns of the ROI that occur during the predefined duration. For example, motion characteristics that evolve due to irregular, non-periodic, or transient motion events can be incorporated into the cluster structure without restarting acquisition or discarding previously acquired data.

In some embodiments, dynamic updating of the plurality of clusters can enforce temporal continuity between adjacent time frames. By encouraging consistency in cluster associations across neighboring time frames, the clustering model can reduce abrupt changes in motion representation that can arise from noise or transient variations in the navigator data. In some embodiments, this temporal continuity can allow the cluster matrix to reflect smooth transitions between motion states while remaining responsive to genuine changes in motion.

The resulting cluster matrix can provide a time resolved representation of motion of the ROI that can serve as an input to subsequent reconstruction steps. By encoding probabilistic associations between time frames and clusters, the cluster matrix can support reconstruction techniques that weight and combine image data according to motion similarity rather than acquisition timing alone. As a result, the cluster matrix can enable reconstruction of images of the ROI that accommodate irregular and non-periodic motion without reliance on rigid temporal binning or external gating signals.

### D. Adaptive Updating and Regularization of Motion States

In some embodiments, the clustering model used to determine the cluster matrix of the region of interest (ROI) can support adaptive updating of motion states over the predefined duration. Motion of the ROI can change over time due to variations in timing, amplitude, or pattern, particularly when the motion exhibits irregular or non-periodic behavior. Adaptive updating can allow the clustering model to incorporate newly acquired navigator data as it becomes available and to adjust the representation of motion states accordingly. This capability can enable the cluster matrix to reflect evolving motion characteristics without requiring predefined motion templates, fixed cycle lengths, or assumptions of periodicity.

In some embodiments, adaptive updating of motion states can include dynamically modifying one or more aspects of the clustering model, including cluster assignments, cluster centroids, similarity measures, or weighting parameters. In some embodiments, the plurality of clusters can be refined iteratively as navigator data accumulates across the predefined duration. For example, motion states that persist over time can become more clearly defined, while transient or infrequent motion states can be represented with lower probability or redistributed across clusters. This adaptive process can allow the clustering model to represent both stable motion patterns and short-lived motion events within a unified framework.

In some embodiments, regularization can be applied during adaptive updating to enforce temporal continuity between adjacent time frames. Temporal continuity regularization can encourage gradual variation in cluster associations from one time frame to the next and can discourage abrupt changes that can arise from noise, undersampling, or transient fluctuations in the navigator data. By promoting consistency across neighboring time frames, temporal continuity regularization can allow the cluster matrix to represent motion as a smoothly varying process while remaining responsive to genuine changes in motion of the ROI.

In addition to temporal continuity, regularization can enforce similarity between clusters of the plurality of clusters. In some embodiments, clusters that represent neighboring motion states can be constrained to remain similar in their motion characteristics, as reflected by cluster centroids or other cluster descriptors. This inter-cluster regularization can promote gradual transitions between motion states and can reduce the likelihood that adjacent clusters represent substantially different motion patterns. By enforcing similarity between clusters, the clustering model can reduce fragmentation of motion states and can improve stability of the cluster matrix over time.

In some embodiments, adaptive updating and regularization can operate jointly with probabilistic cluster assignment. The cluster matrix can comprise non-binary values that represent partial association with multiple clusters at a given time frame, while regularization can guide how these probabilities evolve across time frames and across clusters. This combined approach can allow the cluster matrix to capture uncertainty or overlap between motion states while maintaining coherence in the overall motion representation. As a result, motion can be modeled as a continuous and probabilistic process rather than as a sequence of discrete and isolated states.

In some embodiments, the adaptive updating and regularization of motion states can provide a robust motion representation that serves as an input to subsequent reconstruction steps. By dynamically adapting to changes in motion and by enforcing temporal continuity and inter-cluster similarity, the cluster matrix can support reconstruction techniques that weight and combine image data based on motion similarity rather than acquisition timing alone. This approach can reduce sensitivity to irregular or non-periodic motion and can improve temporal coherence and image quality of reconstructed images of the ROI.

### E. Cluster-Based Image Reconstruction

Using the cluster matrix determined from the navigator data, the disclosed techniques can reconstruct images of the motion of a region of interest (ROI) over the predefined duration in a manner that accounts explicitly for motion characteristics of the ROI. Unlike reconstruction techniques that rely solely on temporal adjacency of image data, cluster-based image reconstruction can use probabilistic associations between time frames and clusters to guide how image data contributes to reconstructed images. This approach can allow reconstruction to reflect motion similarity across time frames while accommodating irregular and non-periodic motion patterns.

In some embodiments, reconstructing images can include weighting image data according to probabilities encoded in the cluster matrix. For each time frame and for each cluster of the plurality of clusters, the cluster matrix can indicate a probability that motion of the ROI associates with the corresponding cluster. Image data acquired at time frames with higher probability association with a given cluster can therefore contribute more strongly to reconstruction of images corresponding to that motion state, while image data associated with lower probabilities can contribute proportionally less. This probabilistic weighting can allow image data from multiple time frames to be incorporated into reconstruction while reflecting uncertainty or overlap between motion states.

In some embodiments, cluster-based reconstruction can include ordering image data based on motion similarity rather than acquisition time. Image data acquired at different time frames can exhibit similar motion characteristics even when separated temporally, particularly when motion is irregular or non-periodic. By using the cluster matrix to identify such similarities, image data associated with similar motion states can be grouped or combined during reconstruction. This ordering based on motion similarity can enable coherent use of image data acquired across multiple motion occurrences without enforcing rigid temporal segmentation.

In some embodiments, the image data can include one or more unresolved or under-sampled areas of the ROI. Such unresolved areas can arise due to undersampling, motion-related inconsistencies, or limitations of acquisition timing. Cluster-based image reconstruction can determine an order and a weighting for each unresolved area using the cluster matrix, such that image data corresponding to similar motion states can be preferentially combined. This approach can improve reconstruction of unresolved areas while maintaining consistency with the motion representation provided by the cluster matrix.

In some embodiments, cluster-based reconstruction can incorporate sensitivity information derived from the image data. For example, when the imaging modality comprises magnetic resonance imaging, a sensitivity map can be determined based on the image data and used during reconstruction. The sensitivity map can represent spatial variations in signal reception and can be incorporated into the reconstruction process alongside cluster-based weighting and combining. This integration can allow spatial encoding effects and motion-related effects to be addressed jointly during reconstruction.

In some embodiments, cluster-based image reconstruction can further include applying regularization along a temporal dimension of the image data using the cluster matrix. Temporal regularization can operate in conjunction with cluster-based weighting to suppress abrupt variations between reconstructed images that can arise from noise, undersampling, or transient motion events. In some embodiments, temporal regularization can comprise total variation regularization, which can encourage piecewise smoothness along the temporal dimension while preserving motion transitions represented in the cluster matrix.

The cluster-based image reconstruction described herein can allow image data acquired over the predefined duration to contribute to reconstructed images in a motion consistent manner. By weighting, ordering, and combining image data based on probabilistic cluster associations, the reconstruction process can leverage data acquired across multiple time frames and motion occurrences while reducing artifacts associated with irregular or non-periodic motion. This approach can improve temporal coherence of reconstructed images without discarding acquired data or relying on rigid gating schemes.

### F. Temporal Regularization and Artifact Suppression

In some embodiments, reconstruction of images of the motion of a region of interest (ROI) can include applying regularization along a temporal dimension of the image data in order to address inconsistencies that arise due to irregular or non-periodic motion. When image data corresponds to motion that varies unpredictably over time, frame-to-frame variations can appear in reconstructed images as flickering, discontinuities, or abrupt intensity changes. Temporal regularization can operate to reduce such variations by encouraging consistency across time frames while allowing motion related changes represented in the cluster matrix to remain visible.

Temporal regularization can function in coordination with the cluster-based reconstruction process described herein. In some embodiments, the cluster matrix can guide how temporal regularization influences reconstructed images by providing probabilistic information about motion similarity across time frames. Time frames that exhibit similar probabilistic associations with one or more clusters can be encouraged to vary smoothly over time, while time frames associated with distinct motion states can retain differences that correspond to genuine motion transitions. In some embodiments, this interaction between temporal regularization and the cluster matrix can allow the reconstruction process to suppress noise driven inconsistencies without obscuring meaningful motion of the ROI.

In some embodiments, temporal regularization can mitigate artifacts that arise when image data acquired at adjacent time frames correspond to substantially different motion states. Such artifacts can occur when motion changes rapidly or when acquisition timing does not align with motion transitions. By applying regularization along the temporal dimension, the reconstruction process can reduce abrupt frame-to-frame variations that do not align with the probabilistic motion representation encoded in the cluster matrix. As a result, reconstructed images can exhibit improved temporal coherence while preserving transitions between motion states that reflect actual motion of the ROI.

In some embodiments, temporal regularization can comprise total variation regularization applied along the temporal dimension of the image data. Total variation regularization can encourage piecewise smooth behavior across time frames while allowing sharp transitions when supported by the data. When used in combination with the cluster matrix, total variation regularization can preferentially smooth temporal variations within a given motion state while allowing changes associated with transitions between clusters. This balance can enable effective suppression of flickering and noise induced artifacts without enforcing uniform smoothing that can blur motion related features.

Temporal regularization can also contribute to reconstruction of image data that includes unresolved or under-sampled areas of the ROI. In such scenarios, limited data availability or motion inconsistencies can exacerbate temporal instability in reconstructed images. Temporal regularization can leverage redundancy across time frames and motion states to stabilize reconstruction of these areas, reducing sensitivity to isolated inconsistencies in the image data. By integrating temporal regularization with cluster-based weighting and combining, the reconstruction process can improve robustness under challenging acquisition conditions.

In some embodiments, parameters governing temporal regularization can be selected based on characteristics of the acquired image data, the navigator data, or the cluster matrix. Such parameters can influence the strength of temporal regularization relative to data fidelity or cluster-based weighting. This flexibility can allow the reconstruction process to adapt to different motion patterns, imaging modalities, or acquisition durations while maintaining consistent artifact suppression behavior.

### G. Representative Imaging Embodiments

The techniques described herein can be applied to a variety of imaging scenarios in which a region of interest (ROI) undergoes motion over a predefined duration. In some embodiments, the ROI can exhibit irregular, non-periodic, or time-varying motion that complicates conventional image reconstruction approaches. By using image data and navigator data to determine a cluster matrix and by reconstructing images based on probabilistic cluster associations, the disclosed techniques can accommodate a wide range of motion patterns and acquisition conditions.

In some embodiments, the imaging modality can comprise magnetic resonance imaging (MRI). In such embodiments, image data and navigator data can be acquired using a free-running acquisition strategy, optionally based on a golden step pulse sequence. The navigator data can capture motion of the ROI over time, and the cluster matrix can represent probabilistic associations between time frames and clusters corresponding to distinct motion states. Reconstruction using cluster-based weighting, combining, and temporal regularization can enable motion-resolved MRI images without reliance on rigid gating or periodic motion assumptions.

In some embodiments, the imaging modality can comprise computed tomography (CT). Image data acquired at different time points can correspond to different motion states of the ROI, such as respiratory or cardiac motion. Navigator data derived from projection data or other motion-sensitive signals can be used to determine a cluster matrix representing motion states over time. Cluster-based reconstruction can weight and combine CT image data according to motion similarity, enabling improved reconstruction under irregular or non-periodic motion conditions.

In some embodiments, the imaging modality can comprise ultrasound imaging. Ultrasound image data can exhibit motion-related variability due to physiological motion or probe movement. Navigator data derived from motion-sensitive ultrasound signals can be used to characterize motion of the ROI. The cluster matrix can represent probabilistic associations between ultrasound frames and motion states, allowing cluster-based reconstruction to improve temporal coherence and reduce motion-related artifacts.

In some embodiments, the imaging modality can comprise positron emission tomography (PET). Motion of the ROI during PET acquisition can introduce blurring or inconsistencies in reconstructed images. Navigator data associated with motion can be used to determine a cluster matrix, and PET image data can be weighted and combined according to probabilistic motion associations. This approach can enable reconstruction that accounts for motion variability while maintaining compatibility with PET acquisition constraints.

In some embodiments, the ROI can comprise anatomical structures other than cardiac tissue, including, but not limited to, lung tissue, abdominal organs, gastrointestinal structures, musculoskeletal structures, or fetal anatomy. Motion of such ROIs can arise from respiration, peristalsis, voluntary movement, or combinations thereof. The disclosed techniques can represent such motion using a plurality of clusters and a cluster matrix and can reconstruct images that accommodate irregular or overlapping motion patterns.

In some embodiments, image data can be acquired while the subject freely breathes. The navigator data can capture respiratory motion concurrently with other motion of the ROI. The cluster matrix can represent combined motion effects, and cluster-based reconstruction with temporal regularization can suppress artifacts associated with respiratory motion while preserving relevant motion characteristics of the ROI.

### 1. Cardiac Imaging

In some embodiments, the region of interest (ROI) can comprise cardiac tissue, and the disclosed techniques can be applied to reconstruction of images of cardiac motion over a predefined duration. Cardiac motion can exhibit complex temporal behavior, including beat-to-beat variability, irregular timing, and non-periodic motion patterns. Such motion characteristics can arise due to arrhythmias, variable heart rates, or interactions between cardiac motion and respiratory motion, and can challenge reconstruction techniques that rely on periodic motion assumptions or rigid gating schemes.

In some embodiments, image data and navigator data corresponding to cardiac motion can be acquired by an imaging modality while the subject freely breathes. The navigator data can capture temporal variations associated with motion of the cardiac ROI and can serve as input to the clustering model used to determine the cluster matrix. Because the navigator data can be acquired concurrently with the image data over the predefined duration, motion information can remain temporally aligned with spatial information used during reconstruction, even when cardiac motion varies irregularly over time.

In some embodiments, the cluster matrix determined for a cardiac ROI can represent a plurality of clusters corresponding to distinct cardiac motion states. For each time frame within the predefined duration and for each cluster of the plurality of clusters, the cluster matrix can indicate a probability that cardiac motion captured by the navigator data associates with the corresponding cluster. This probabilistic representation can allow partial association with multiple cardiac motion states at a given time frame, thereby accommodating overlap between motion states and beat-to-beat variability that can occur during irregular cardiac motion.

In some embodiments, the clustering model can dynamically update the plurality of clusters as cardiac motion evolves over the predefined duration. Dynamic updating can allow the cluster matrix to adapt to changes in cardiac motion patterns, including changes in contraction timing, relaxation behavior, or relative motion amplitude. Regularization applied during adaptive updating can enforce temporal continuity between adjacent time frames and similarity between adjacent clusters, enabling a smooth and coherent representation of cardiac motion while remaining responsive to genuine changes in motion.

In some embodiments, images of cardiac motion can be reconstructed by weighting and combining image data based on the cluster matrix for the cardiac ROI. Image data acquired at different time frames that correspond to similar cardiac motion states can be coherently combined during reconstruction, even when separated in time. This cluster-based reconstruction can allow image data acquired across multiple cardiac cycles to contribute to reconstructed images while preserving motion consistency and reducing artifacts associated with irregular or non-periodic cardiac motion.

In some embodiments, reconstruction of cardiac images can further include applying regularization along a temporal dimension of the image data using the cluster matrix. Temporal regularization can suppress artifacts such as flickering or abrupt frame-to-frame variations that can arise due to irregular cardiac motion, undersampling, or noise. In some embodiments, temporal regularization can comprise total variation regularization applied along the temporal dimension, allowing smooth temporal behavior while preserving transitions between cardiac motion states represented in the cluster matrix.

In some embodiments, the imaging modality can comprise magnetic resonance imaging, and the navigator data can be acquired without reliance on electrocardiogram (ECG) gating. By avoiding dependence on ECG gating, the disclosed techniques can reconstruct images of cardiac motion even when ECG signals are unreliable, unavailable, or inconsistent with mechanical motion of the heart. This capability can enable robust reconstruction of cardiac images under conditions in which conventional gated imaging techniques can fail.

In some embodiments, imaging data from subjects exhibiting irregular cardiac motion and from a subject exhibiting regular cardiac motion can be analyzed to illustrate qualitative performance of clustering behavior. The data can include image data and navigator data acquired during cardiac imaging in which arrhythmic motion occurs during acquisition.

In some embodiments, data collected from a subject exhibiting premature ventricular contractions and from a subject exhibiting atrial fibrillation during image acquisition can be analyzed. Illustrations can include cluster value similarity matrices and cluster binning results. For the cluster value similarity matrices, one axis can indicate cluster index and a color scale can indicate similarity values for data points within each cluster, where lower values represent reduced similarity and higher values represent increased similarity.

In the setting of premature ventricular contractions, periods of abnormal cardiac motion can occur intermittently among periods of more regular motion. Such patterns can be reflected in the recorded timing signals acquired concurrently with imaging. Distinct motion patterns can be observed in illustrations of cluster value similarity matrices and cluster binning results.

Cluster value similarity matrices can illustrate that the disclosed method can accommodate variation in motion patterns, including shifts between abnormal heartbeats and more regular heartbeats. Cluster matrices generated using the disclosed method and comparator clustering approaches can both show different temporal patterns during different motion regimes. However, in some embodiments, results generated using the disclosed method can show greater variation in similarity values across clusters at each time point, consistent with shifts in motion periodicity.

In cluster binning results, the disclosed method can suppress abrupt temporal changes during binning more effectively than comparator clustering approaches. Separation of motion states along the temporal dimension can be more clearly defined. In some embodiments, adjacent clusters in the cluster centroid matrix can exhibit improved continuity relative to comparator methods. In contrast, centroid values generated by comparator clustering approaches can exhibit abrupt or noise-like patterns along the cluster index dimension. These differences in behavior can reflect intrinsic differences between clustering approaches.

In comparator clustering approaches, the clustering cost function can include a data fidelity term alone, and cluster membership can be represented using binary values. In contrast, the disclosed method can include additional regularization terms that enforce smoothness of motion state transitions and smoothness of cluster transitions, and can employ a probability-like cluster matrix. In addition, reconstruction using the disclosed method can include temporal total variation regularization, whereas comparator approaches can omit such regularization. These features can contribute to improved qualitative clustering behavior.

For subjects exhibiting atrial fibrillation, variations in cycle timing can be observed in recorded timing signals. Cluster value similarity matrices can illustrate that the disclosed method can handle time-varying motion patterns intrinsic to atrial fibrillation. A wider range of similarity scores across clusters can be observed. Cluster binning results can illustrate suppression of abrupt changes while maintaining sensitivity to irregular cardiac motion. Cluster centroid matrices generated using the disclosed method can exhibit continuity of adjacent clusters, whereas comparator methods can show abrupt or noisy patterns.

The probability-like cluster matrix employed by the disclosed method can distribute high values more effectively along the temporal dimension relative to comparator methods. Unlike binary cluster membership, the probabilistic cluster matrix can represent motion states in a manner more closely aligned with underlying cardiac rhythm.

In some embodiments, recorded timing signals and corresponding self-correlation maps of the cluster matrix can be analyzed. Self-correlation maps can illustrate correlation of cluster associations over time. For regular cardiac motion, self-correlation maps can show repetitive and highly correlated patterns indicative of periodic motion. For motion associated with premature ventricular contractions, self-correlation maps can show reduced regularity while maintaining partial periodicity. For atrial fibrillation, self-correlation maps can show absence or reduction of repeating correlation patterns, consistent with irregular and non-periodic cardiac motion.

In some embodiments, qualitative and quantitative image quality metrics can be compared across reconstruction methods. Image quality can be assessed using qualitative scoring scales for single-phase images and multiphase cine images. The disclosed method can generate a higher proportion of images receiving higher quality scores relative to comparator clustering approaches and reference real-time imaging approaches.

Single-phase images generated using the disclosed method can exhibit reduced image artifacts relative to comparator methods. Images reconstructed using the disclosed method with temporal total variation regularization can exhibit continuous shape changes, whereas images reconstructed using comparator clustering approaches can exhibit abrupt temporal changes.

Multiphase cine images generated using the disclosed method can receive higher qualitative scores than those generated using comparator methods. Cine video examples can illustrate that the disclosed method can reduce flickering artifacts that degrade images generated using comparator clustering approaches. Inter-reader agreement for qualitative scoring can indicate moderate agreement.

In some embodiments, images generated using the disclosed method and reference real-time approaches can be analyzed across subjects exhibiting different motion characteristics. The disclosed method can generate diastolic and systolic images with reduced artifacts across different motion conditions. Without reliance on external timing signals, the disclosed method can cluster data points corresponding to similar motion states consistently across different motion patterns.

Quantitative comparisons can show that signal-to-noise ratio and contrast-to-noise ratio values generated using the disclosed method can exceed those generated using comparator clustering approaches. Edge sharpness measurements can also indicate improved sharpness for images reconstructed using the disclosed method relative to comparator approaches.

In some embodiments, ventricular area change derived from reconstructed images can be analyzed as a function of preceding motion cycle timing. A regression analysis can demonstrate a relationship between ventricular area change and the preceding motion interval. Such analysis can illustrate that ventricular function metrics derived from the disclosed method can reflect physiological variability associated with irregular motion patterns.

In some embodiments, cardiac function metrics derived using the disclosed method and a reference real-time method can be compared. Paired statistical analysis can indicate no significant difference between metrics derived from the disclosed method and the reference method.

Agreement analysis can demonstrate clinically negligible mean bias between function metrics derived from the disclosed method and reference real-time imaging. A substantial proportion of data points can fall within defined limits of agreement. Functional parameters including ventricular volumes, ejection fraction, and mass can show strong agreement between methods.

a. Data Acquisition and Preprocessing

In some embodiments, subjects with cardiac rhythm variability and one or more subjects with regular rhythm can undergo cardiac imaging in compliance with applicable institutional review requirements and patient privacy regulations. Written informed consent can be obtained prior to participation. In some embodiments, subjects can exhibit arrhythmic motion during image acquisition.

In some embodiments, imaging can be performed using a clinical imaging scanner and a multi-channel receive coil. Image data can be acquired using both a sorted Cartesian golden step pulse sequence and a reference real-time imaging sequence. The image data can include multiple imaging slices oriented to cover a region of interest corresponding to the ventricle. The reference real-time sequence can include a Cartesian balanced steady-state free precession (bSSFP) readout with inline reconstruction.

In some embodiments, acquisitions can be performed with breath-holding to minimize respiratory-motion-related differences between acquisition techniques. An electrocardiogram (ECG) signal can be simultaneously recorded during data acquisition and can be used for timing purposes in the disclosed algorithm.

In some embodiments, the sorted golden step pulse sequence can include additional k-space center lines introduced after selected repetition times within a free-running Cartesian sequence with a sorted golden-step trajectory and bSSFP readout. The additional k-space center lines can act as motion navigators and can be combined into a single matrix with dimensions corresponding to receive coils, encoding direction, and time. An inverse fast Fourier transform can be applied in the frequency encoding direction to convert frequency information to one-dimensional spatial projections.

In some embodiments, a first-order difference of the projections can be calculated, and first-order differences from multiple coils can be concatenated into a data matrix. Principal component analysis can be applied along the coil dimension at each time point to generate a compact matrix that can serve as input to subsequent clustering algorithms.

b. Clustering of Cardiac Motion States

In some embodiments, a k-means clustering approach for handling cardiac motion states can be used as a comparator to the disclosed method. K-means clustering can be applied to the compressed motion navigator matrix, and data points representing similar cardiac motion states can be assigned to clusters based on similarity of motion information derived from k-space navigator lines. Navigator lines assigned to the same cluster can be considered to reflect similar motion. Cluster assignments can be used for data binning during reconstruction, whereby data within each cluster can be assumed to reflect one cardiac phase.

An imaging framework for Dynamic Regularized Adaptive Cluster Optimization (DRACO) can include a data acquisition step in which navigator data and image data are acquired using the sorted golden step pulse sequence. During cluster analysis, navigator data can be separated from image data and can serve as input to the clustering algorithm to generate a cluster matrix that represents cardiac motion. The cluster matrix can describe a likelihood probability that motion from the navigator data at each time frame belongs to a specific cluster, thereby resolving irregular motion.

In some embodiments, regularization of similarity between adjacent clusters and adjacent time frames can be applied to generate a final cluster matrix. In a time-resolved reconstruction step, the cluster matrix can be applied to order and weight unsolved image data in a pseudo-real-time formulation to mimic non-periodic motion patterns. Sensitivity maps can be calculated based on the image data, and a sampling operator can be defined based on the data acquisition pattern. To generate final images, total variation regularization can be applied along a temporal dimension.

In contrast to conventional clustering approaches, the disclosed method can estimate probabilistic associations between k-space data at each time point and intrinsic mechanical motion states. This feature can enable depiction of smooth transitions between dynamic motion states regardless of motion regularity and can enable iterative adaptation. Regularization can be imposed on clustering geometry to integrate varying motion patterns and sequential temporal ordering. An optimization-driven adaptive scheme can provide a single framework for handling both periodic and non-periodic motion patterns.

In some embodiments, motion state association can be described by a nonnegative matrix with columns constrained to a probability simplex, where each column can describe the likelihood and level of contribution of sampled data at a given time point to a corresponding motion phase. Motion phases can be represented by cluster centroids. The association matrix and cluster configurations can be jointly estimated by minimizing a cost function that includes a data fidelity term, a regularization term encouraging piecewise smooth motion state transitions, and a regularization term encouraging smooth transitions between adjacent cluster centers.

c. Imaging Reconstruction

In regular motion conditions, motion patterns can exhibit periodic behavior. In contrast, under irregular motion conditions, motion patterns can vary with cycle length, and some cycles can include fewer motion phases.

For comparator clustering approaches, image reconstruction can be performed using sensitivity-based reconstruction techniques applied to each cluster bin. Temporal ordering of reconstructed images can be determined based on timing signals or sequential time stamps derived from navigator data.

For the disclosed reconstruction approach, the cluster matrix can be employed to generate images from uncertain motion patterns. Reconstructed images can result from minimizing a cost function that includes k-space data fidelity and temporal total variation regularization. K-space data fidelity can account for undersampling, coil sensitivity maps, Fourier transform operations, and the cluster matrix. The cluster matrix can govern how k-space data from different motion cycles are softly combined at each time point to render corresponding images.

In some embodiments, a weighting parameter can control a balance between data fidelity and dynamic motion states. When generating pseudo-real-time image sequences, the cluster having the largest value at each time point can determine the image corresponding to that time point. Through an iterative process, a pseudo-real-time image sequence can be produced.

For comparison, real-time images can also be reconstructed directly from a reference real-time acquisition, wherein each image frame can be generated using temporally adjacent k-space data.

d. Assessment of Image Quality and Functional Measures

In some embodiments, image quality can be assessed by multiple readers using a qualitative scoring scale. Images generated using the disclosed approach, comparator clustering approaches, and reference real-time approaches can be randomized and evaluated in a blinded manner. Representative images corresponding to different motion phases and slices can be evaluated both individually and in cine display mode.

Quantitative image quality metrics can include signal-to-noise ratio, contrast-to-noise ratio, and edge sharpness. Signal-to-noise ratio can be calculated using regions of interest drawn in selected tissue regions and background regions to quantify noise. Contrast-to-noise ratio can be calculated between tissue types. Relative ratios of quantitative metrics between reconstruction approaches can also be computed.

Edge sharpness can be evaluated by analyzing signal intensity profiles across anatomical boundaries and computing slope values over selected intensity percentiles. Larger slope values can represent sharper edges.

In some embodiments, functional measures derived from reconstructed images can be evaluated by analyzing relationships between motion cycle timing and changes in anatomical area. Area change curves can be generated from reconstructed image sequences, and regression analysis can be performed to evaluate relationships between timing parameters and area changes.

In some embodiments, commercially available software can be used to quantify functional parameters such as volumes, mass, and ejection fraction from reconstructed image stacks. Functional values can be calculated by averaging measurements across multiple motion cycles.

e. Statistical Analysis

Statistical analysis can be performed using standard statistical software. Categorical variables can be summarized as frequencies or percentages, and continuous variables can be summarized using descriptive statistics. Normality testing can be performed prior to selecting appropriate statistical tests. Group comparisons can be performed using parametric or nonparametric tests as appropriate. Inter-reader agreement can be assessed using kappa statistics. Regression analysis and agreement analysis can be performed to evaluate relationships and biases between reconstruction approaches.

f. Theory for DRACO Algorithm

In some embodiments, a nonnegative membership matrix can represent associations between time points and motion phases, with each column constrained to a probability simplex. Cluster centroids can represent motion states. Associations and cluster centers can be jointly estimated by minimizing an objective function that includes a data fidelity term, a temporal smoothness term encouraging smooth state transitions, and a regularization term encouraging smooth transitions between adjacent cluster centers.

g. Image Reconstruction for DRACO

In some embodiments, reconstructed images can be generated by minimizing an objective function that enforces fidelity to k-space data and temporal total variation regularization. Undersampling operators, Fourier transforms, sensitivity maps, and the cluster matrix can be incorporated into the reconstruction formulation. The cluster matrix can govern how k-space data from different motion cycles are softly combined to render images at each time point.

In some embodiments, a temporal self-correlation matrix derived from the cluster matrix can be used to visualize temporal regularity or irregularity of motion. Periodic motion can produce repeating diagonal patterns in the self-correlation matrix, while non-periodic motion can lack such patterns or exhibit variable spacing between patterns.

### 2. Lung Imaging

In some embodiments, the region of interest (ROI) can comprise lung tissue, and the disclosed techniques can be applied to reconstruction of images of lung motion over a predefined duration. Lung motion can arise primarily from respiration and can exhibit irregular, non-periodic, or variable breathing patterns, including changes in breathing depth, rate, or rhythm. Such motion characteristics can challenge reconstruction techniques that rely on fixed respiratory phases or regular breathing assumptions.

In some embodiments, image data and navigator data corresponding to lung motion can be acquired by an imaging modality while the subject freely breathes. The navigator data can capture temporal variations associated with respiratory motion of the lung ROI and can serve as input to the clustering model used to determine the cluster matrix. Because the navigator data can be acquired concurrently with the image data over the predefined duration, motion information can remain temporally aligned with spatial information used during reconstruction, even when respiratory motion varies unpredictably over time.

In some embodiments, the cluster matrix determined for a lung ROI can represent a plurality of clusters corresponding to distinct respiratory motion states. For each time frame within the predefined duration and for each cluster of the plurality of clusters, the cluster matrix can indicate a probability that lung motion captured by the navigator data associates with the corresponding cluster. This probabilistic representation can allow partial association with multiple respiratory motion states at a given time frame, thereby accommodating transitions between inhalation and exhalation as well as irregular breathing patterns.

In some embodiments, the clustering model can dynamically update the plurality of clusters as respiratory motion evolves over the predefined duration. Dynamic updating can allow the cluster matrix to adapt to changes in breathing behavior, including variations in respiratory amplitude or timing. Regularization applied during adaptive updating can enforce temporal continuity between adjacent time frames and similarity between adjacent clusters, enabling smooth representation of respiratory motion while remaining responsive to genuine changes in lung motion.

In some embodiments, images of lung motion can be reconstructed by weighting and combining image data based on the cluster matrix for the lung ROI. Image data acquired at different time frames that correspond to similar respiratory motion states can be coherently combined during reconstruction, even when separated in time. This cluster-based reconstruction can allow image data acquired across multiple breathing cycles to contribute to reconstructed images while preserving motion consistency and reducing artifacts associated with irregular respiratory motion.

In some embodiments, reconstruction of lung images can further include applying regularization along a temporal dimension of the image data using the cluster matrix. Temporal regularization can suppress artifacts such as blurring, streaking, or abrupt frame-to-frame variations that can arise due to irregular respiratory motion or undersampling. In some embodiments, temporal regularization can comprise total variation regularization applied along the temporal dimension, allowing smooth temporal behavior while preserving transitions between respiratory motion states represented in the cluster matrix.

In some embodiments, the imaging modality can comprise magnetic resonance imaging, computed tomography, ultrasound imaging, or positron emission tomography. For example, in CT or PET embodiments, the disclosed techniques can reduce motion induced blurring of lung structures caused by respiratory motion during acquisition. In MRI or ultrasound embodiments, the techniques can improve temporal coherence of lung images acquired during free breathing.

### 3. Abdominal Imaging

In some embodiments, the region of interest (ROI) can comprise one or more abdominal organs, including liver tissue, pancreatic tissue, renal tissue, or combinations thereof, and the disclosed techniques can be applied to reconstruction of images of abdominal motion over a predefined duration. Motion of abdominal organs can arise primarily from respiration and can further include organ specific motion such as deformation, displacement, or interaction with surrounding anatomical structures. Such motion can exhibit irregular, non-periodic, or time-varying characteristics that challenge reconstruction techniques relying on breath hold consistency or fixed respiratory phase assumptions.

In some embodiments, image data and navigator data corresponding to abdominal motion can be acquired by an imaging modality while the subject freely breathes. The navigator data can capture temporal variations associated with respiratory motion of the abdominal ROI and can serve as input to the clustering model used to determine the cluster matrix. Because the navigator data can be acquired concurrently with the image data over the predefined duration, motion information can remain temporally aligned with spatial information used during reconstruction, even when breathing patterns vary in depth, rate, or regularity.

In some embodiments, the cluster matrix determined for an abdominal ROI can represent a plurality of clusters corresponding to distinct abdominal motion states. For each time frame within the predefined duration and for each cluster of the plurality of clusters, the cluster matrix can indicate a probability that abdominal motion captured by the navigator data associates with the corresponding cluster. This probabilistic representation can allow partial association with multiple motion states at a given time frame, thereby accommodating gradual transitions between respiratory phases and variability in abdominal motion patterns.

In some embodiments, the clustering model can dynamically update the plurality of clusters as abdominal motion evolves over the predefined duration. Dynamic updating can allow the cluster matrix to adapt to changes in respiratory behavior, including variations in breathing amplitude or timing, as well as transient motion events such as coughing or voluntary movement. Regularization applied during adaptive updating can enforce temporal continuity between adjacent time frames and similarity between adjacent clusters, enabling smooth representation of abdominal motion while remaining responsive to genuine changes in motion.

In some embodiments, images of abdominal motion can be reconstructed by weighting and combining image data based on the cluster matrix for the abdominal ROI. Image data acquired at different time frames that correspond to similar abdominal motion states can be coherently combined during reconstruction, even when separated in time. This cluster-based reconstruction can allow image data acquired across multiple respiratory cycles to contribute to reconstructed images while preserving motion consistency and reducing artifacts associated with irregular respiratory motion.

In some embodiments, reconstruction of abdominal images can further include applying regularization along a temporal dimension of the image data using the cluster matrix. Temporal regularization can suppress artifacts such as blurring, ghosting, or abrupt frame-to-frame variations that can arise due to irregular respiratory motion or undersampling. In some embodiments, temporal regularization can comprise total variation regularization applied along the temporal dimension, allowing smooth temporal behavior while preserving transitions between abdominal motion states represented in the cluster matrix.

In some embodiments, the imaging modality can comprise magnetic resonance imaging, computed tomography, ultrasound imaging, or positron emission tomography. For example, in MRI embodiments, the disclosed techniques can enable free-breathing abdominal imaging without reliance on breath-holds or respiratory gating. In CT or PET embodiments, the techniques can reduce motion-induced blurring of abdominal structures caused by respiratory motion during acquisition.

### 4. Gastrointestinal (GI) Imaging

In some embodiments, the region of interest (ROI) can comprise gastrointestinal tissue, including one or more portions of the esophagus, stomach, small intestine, colon, or combinations thereof, and the disclosed techniques can be applied to reconstruction of images of gastrointestinal motion over a predefined duration. Gastrointestinal motion can arise from peristalsis, organ filling and emptying, voluntary or involuntary muscle contractions, or interactions with respiratory motion. Such motion can exhibit irregular, non-periodic, and localized behavior that can vary substantially over time and across different regions of the gastrointestinal tract.

In some embodiments, image data and navigator data corresponding to gastrointestinal motion can be acquired by an imaging modality while the subject freely breathes. The navigator data can capture temporal variations associated with motion of the gastrointestinal ROI, including transient or localized motion events. Because the navigator data can be acquired concurrently with the image data over the predefined duration, motion information can remain temporally aligned with spatial information used during reconstruction, even when gastrointestinal motion occurs sporadically or unpredictably.

In some embodiments, the cluster matrix determined for a gastrointestinal ROI can represent a plurality of clusters corresponding to distinct gastrointestinal motion states. For each time frame within the predefined duration and for each cluster of the plurality of clusters, the cluster matrix can indicate a probability that gastrointestinal motion captured by the navigator data associates with the corresponding cluster. This probabilistic representation can allow partial association with multiple motion states at a given time frame, thereby accommodating overlap between motion states and gradual transitions associated with peristaltic activity.

In some embodiments, the clustering model can dynamically update the plurality of clusters as gastrointestinal motion evolves over the predefined duration. Dynamic updating can allow the cluster matrix to adapt to changes in motion patterns, including initiation, propagation, or cessation of peristaltic waves. Regularization applied during adaptive updating can enforce temporal continuity between adjacent time frames and similarity between adjacent clusters, enabling a smooth and coherent representation of gastrointestinal motion while remaining responsive to localized or transient motion events.

In some embodiments, images of gastrointestinal motion can be reconstructed by weighting and combining image data based on the cluster matrix for the gastrointestinal ROI. Image data acquired at different time frames that correspond to similar gastrointestinal motion states can be coherently combined during reconstruction, even when separated in time. This cluster-based reconstruction can allow image data acquired across multiple peristaltic cycles or motion events to contribute to reconstructed images while preserving motion consistency and reducing artifacts associated with irregular or sporadic gastrointestinal motion.

In some embodiments, reconstruction of gastrointestinal images can further include applying regularization along a temporal dimension of the image data using the cluster matrix. Temporal regularization can suppress artifacts such as blurring, ghosting, or abrupt frame-to-frame variations that can arise due to irregular peristaltic motion or undersampling. In some embodiments, temporal regularization can comprise total variation regularization applied along the temporal dimension, allowing smooth temporal behavior while preserving transitions between gastrointestinal motion states represented in the cluster matrix.

In some embodiments, the imaging modality can comprise magnetic resonance imaging, computed tomography, ultrasound imaging, or positron emission tomography. For example, in MRI embodiments, the disclosed techniques can enable free-breathing gastrointestinal imaging without reliance on anti-peristaltic agents or rigid timing constraints. In ultrasound embodiments, the techniques can improve temporal coherence of gastrointestinal images acquired during real-time scanning. In CT or PET embodiments, the techniques can reduce motion-induced blurring associated with gastrointestinal motion during acquisition.

### 5. Fetal Imaging

In some embodiments, the region of interest (ROI) can comprise fetal tissue, including fetal organs, fetal anatomy, or combinations thereof, and the disclosed techniques can be applied to reconstruction of images of fetal motion over a predefined duration. Fetal motion can exhibit complex, irregular, and non-periodic behavior, including spontaneous fetal movement, changes in fetal orientation, and interactions with maternal respiration. Such motion characteristics can challenge reconstruction techniques that rely on periodic motion assumptions, external gating, or repeatable motion cycles.

In some embodiments, image data and navigator data corresponding to fetal motion can be acquired by an imaging modality while the pregnant subject freely breathes. The navigator data can capture temporal variations associated with motion of the fetal ROI as well as motion arising from maternal respiration. Because the navigator data can be acquired concurrently with the image data over the predefined duration, motion information can remain temporally aligned with spatial information used during reconstruction, even when multiple motion sources overlap or vary unpredictably over time.

In some embodiments, the cluster matrix determined for a fetal ROI can represent a plurality of clusters corresponding to distinct fetal motion states. For each time frame within the predefined duration and for each cluster of the plurality of clusters, the cluster matrix can indicate a probability that motion captured by the navigator data associates with the corresponding cluster. This probabilistic representation can allow partial association with multiple fetal motion states at a given time frame, thereby accommodating overlap between motion states arising from fetal movement and maternal respiration.

In some embodiments, the clustering model can dynamically update the plurality of clusters as fetal motion evolves over the predefined duration. Dynamic updating can allow the cluster matrix to adapt to changes in fetal motion patterns, including sudden fetal movements, gradual repositioning, or periods of relative quiescence. Regularization applied during adaptive updating can enforce temporal continuity between adjacent time frames and similarity between adjacent clusters, enabling a coherent representation of fetal motion while remaining responsive to transient or localized motion events.

In some embodiments, images of fetal motion can be reconstructed by weighting and combining image data based on the cluster matrix for the fetal ROI. Image data acquired at different time frames that correspond to similar fetal motion states can be coherently combined during reconstruction, even when separated in time. This cluster-based reconstruction can allow image data acquired across multiple fetal motion events to contribute to reconstructed images while preserving motion consistency and reducing artifacts associated with irregular or unpredictable fetal movement.

In some embodiments, reconstruction of fetal images can further include applying regularization along a temporal dimension of the image data using the cluster matrix. Temporal regularization can suppress artifacts such as blurring, ghosting, or abrupt frame-to-frame variations that can arise due to sudden fetal movement or overlapping motion sources. In some embodiments, temporal regularization can comprise total variation regularization applied along the temporal dimension, allowing smooth temporal behavior while preserving transitions between fetal motion states represented in the cluster matrix.

In some embodiments, the imaging modality can comprise magnetic resonance imaging or ultrasound imaging. For example, in fetal MRI embodiments, the disclosed techniques can enable motion-resolved imaging without reliance on fetal or maternal gating signals. In ultrasound embodiments, the techniques can improve temporal coherence of fetal images acquired during real-time scanning despite spontaneous fetal movement.

### 6. Oropharyngeal Imaging

In some embodiments, the region of interest (ROI) can comprise oropharyngeal tissue, including one or more structures of the oral cavity, pharynx, soft palate, tongue, or surrounding musculature, and the present techniques can be applied to reconstruction of images of oropharyngeal motion over a predefined duration. Oropharyngeal motion can arise from swallowing, tongue movement, speech-related activity, respiration, reflexive muscle activation, or combinations thereof. Such motion can exhibit irregular, non-periodic, and occasionally abrupt behavior, including rapid onset and cessation of swallowing events and complex, non-repetitive tongue motion.

In some embodiments, image data and navigator data corresponding to oropharyngeal motion can be acquired by an imaging modality while the subject performs natural swallowing, tongue movement, or other oropharyngeal activity, or while the subject remains at rest. The navigator data can capture temporal variations associated with localized motion of the tongue and surrounding oropharyngeal structures and can serve as input to the clustering model used to determine the cluster matrix. Because the navigator data can be acquired concurrently with the image data over the predefined duration, motion information can remain temporally aligned with spatial information used during reconstruction, even when swallowing or tongue motion occurs sporadically or unpredictably.

In some embodiments, the cluster matrix determined for an oropharyngeal ROI can represent a plurality of clusters corresponding to distinct oropharyngeal motion states, including motion states associated with swallowing events, tongue displacement, and intervening quiescent periods. For each time frame within the predefined duration and for each cluster of the plurality of clusters, the cluster matrix can indicate a probability that motion captured by the navigator data associates with the corresponding cluster. This probabilistic representation can allow partial association with multiple motion states at a given time frame, thereby accommodating overlap between motion patterns and gradual or abrupt transitions associated with swallowing and tongue movement.

In some embodiments, the clustering model can dynamically update the plurality of clusters as oropharyngeal motion evolves over the predefined duration. Dynamic updating can allow the cluster matrix to adapt to changes in motion patterns, including sudden swallowing events, rapid tongue motion, or shifts between active and inactive motion states. Regularization applied during adaptive updating can enforce temporal continuity between adjacent time frames and similarity between adjacent clusters, enabling a coherent representation of oropharyngeal motion while remaining responsive to non-periodic and occasionally abrupt motion events.

In some embodiments, images of oropharyngeal motion can be reconstructed by weighting and combining image data based on the cluster matrix for the oropharyngeal ROI. Image data acquired at different time frames that correspond to similar tongue or swallowing motion states can be coherently combined during reconstruction, even when separated in time. This cluster-based reconstruction can allow image data acquired across multiple swallowing events or tongue movements to contribute to reconstructed images while preserving motion consistency and reducing artifacts associated with irregular or abrupt motion.

In some embodiments, reconstruction of oropharyngeal images can further include applying regularization along a temporal dimension of the image data using the cluster matrix. Temporal regularization can suppress artifacts such as blurring, ghosting, or abrupt frame-to-frame variations that can arise due to rapid tongue motion or swallowing-related displacement. In some embodiments, temporal regularization can comprise total variation regularization applied along the temporal dimension, allowing smooth temporal behavior while preserving sharp transitions between distinct motion states represented in the cluster matrix.

In some embodiments, the imaging modality can comprise magnetic resonance imaging, computed tomography, ultrasound imaging, or combinations thereof. For example, in MRI embodiments, the disclosed techniques can enable motion-resolved imaging of the tongue and oropharynx without reliance on rigid timing constraints or externally imposed swallowing protocols. In ultrasound embodiments, the techniques can improve temporal coherence of images acquired during dynamic assessment of swallowing and tongue motion.

Accordingly, the oropharyngeal imaging embodiments described herein illustrate application of the disclosed techniques to reconstruction of images of oropharyngeal tissue undergoing complex, non-periodic, and occasionally abrupt motion. By using navigator-derived motion clustering, adaptive updating, cluster-based reconstruction, and temporal regularization, the disclosed approach can capture swallowing-related and tongue-related motion patterns and support robust reconstruction suitable for visualization and functional analysis without reliance on predictable or periodic motion assumptions.

### IV. Machine Learning Model

In some embodiments, one or more steps of the methods described herein can be implemented using a trained machine learning model. The trained machine learning model can be configured to process image data, navigator data, derived features, or combinations thereof, and can generate outputs used in clustering, motion characterization, cluster matrix determination, regularization, or image reconstruction.

In some embodiments, the trained machine learning model can be used to assist in determining the cluster matrix by learning associations between navigator data and motion states. For example, the trained machine learning model can receive navigator data or features derived therefrom as input and can output values representing associations with a plurality of clusters. The output of the trained machine learning model can comprise non-binary values that represent partial or probabilistic association with multiple clusters, and such outputs can be incorporated into or combined with the cluster matrix described herein.

In some embodiments, the trained machine learning model can be used to adaptively update clustering behavior over a predefined duration. The trained machine learning model can learn temporal patterns in the navigator data and can assist in enforcing temporal continuity between adjacent time frames or similarity between adjacent clusters. In this manner, the trained machine learning model can support representation of irregular, non-periodic, or occasionally abrupt motion patterns without reliance on predefined motion models.

In some embodiments, the trained machine learning model can be used to estimate parameters associated with regularization. For example, the trained machine learning model can output values that influence weighting of regularization terms, selection of regularization strength, or adaptation of regularization behavior based on characteristics of the image data, navigator data, or motion patterns. This can allow regularization to be dynamically adjusted while preserving data fidelity.

In some embodiments, the trained machine learning model can be used during image reconstruction to guide weighting, ordering, or combining of image data. For example, the trained machine learning model can assist in identifying unresolved areas of a region of interest, predicting motion-consistent data combinations, or suppressing artifacts associated with irregular motion. The trained machine learning model can operate independently or in combination with optimization-based reconstruction techniques described herein.

In some embodiments, the trained machine learning model can be trained using supervised learning, unsupervised learning, semi-supervised learning, self-supervised learning, reinforcement learning, or combinations thereof. Training data can include previously acquired image data, navigator data, simulated data, annotated data, or combinations thereof. The trained machine learning model can be trained offline and deployed during image acquisition or reconstruction, or can be updated periodically as additional data becomes available.

In some embodiments, the trained machine learning model can comprise one or more neural networks, decision trees, ensemble models, clustering models, regression models, or combinations thereof. The trained machine learning model can be implemented using software, hardware, or combinations thereof, including execution on one or more processors, graphics processing units, or specialized accelerators.

Accordingly, incorporation of a trained machine learning model into one or more steps of the disclosed methods can provide additional flexibility, robustness, and adaptability in handling complex motion patterns and reconstruction tasks. The use of trained machine learning models does not limit the disclosed methods to any particular model architecture or training approach and can be combined with rule-based, optimization-based, or physics-based techniques described herein.

### V. Non-Limiting Exemplary Framework for Dynamically and Adaptively Resolving Motions in Imaging

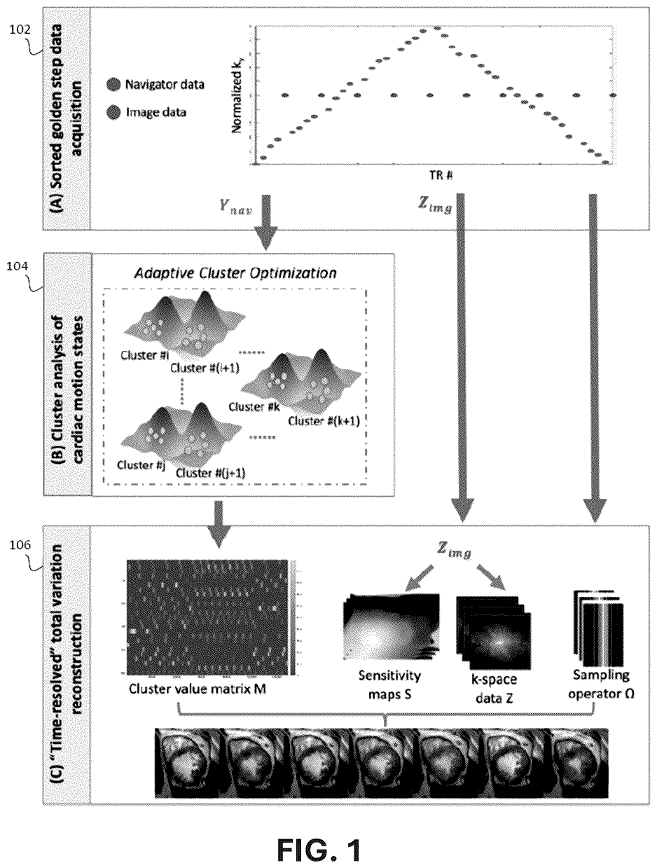

FIG. 1 is a schematic showing an example framework for dynamically and adaptively resolving motion in imaging, according to example embodiments of the present disclosure. Although FIG. 1 depicts data for cardiac motion, it is contemplated that the same framework can be applied to dynamically and adaptively resolve periodic and non-periodic motion for other physiological processes as well, such as but not limited to respiratory motion in the lung, digestion, and brain activity.

The presently disclosed techniques for dynamically and adaptively resolving motion in imaging involves acquiring image data and navigator data of a physiological process (e.g., a region of interest in a patient exhibiting the physiological process) over a predefined duration (block 102). In some embodiments, acquiring the image data and navigator data can involve acquiring imaging slices over a predefined time frame according to a Cartesian golden-step sequence. The imaging slices and/or image data can be acquired via any imaging modality or combination of imaging modalities (e.g., magnetic resonance imaging (MRI), computerized tomography (CT), electrocardiogram (ECG), ultrasound imaging, positron emission tomography (PET), single-photon emission computed tomography (SPECT), X-ray, photoacoustic imaging, etc.). In some embodiment, in order to resolve motion, the patient from which the images are captured can hold their breath over the predefined duration. Alternatively, in some embodiments, the patient can breathe freely during the acquisition, for example, to capture a region of interest that also or alternatively encompasses the lungs (e.g., for respiratory motion). In some embodiments, the acquired image data can be in k-space. Navigator information can be extracted from the acquired data for the predefined duration. In some embodiments, the navigator data can be based on samples of the acquired image data at different time points of the predefined duration that indicate motion. The navigator data can be arranged as a compressed motion navigator matrix Y.

The presently disclosed techniques further includes utilizing a dynamic regularized adaptive cluster optimization (DRACO) (block 104). In some embodiments, DRACO includes generating a cluster matrix based on estimated probabilities (e.g., probabilistic associations) between k-space data from the image acquisition at each time point in the predefined duration and the intrinsic phase of the physiological process (e.g., a time-phase association of mechanical motion states, such as of mechanical cardiac motion states). For example, a clustering model can be applied to the compressed motion navigator matrix Y to assign, for each navigator data, probabilities to various clusters based on similarity of motion information from k-space navigator lines. Navigator lines in the same cluster can be considered to have similar motion. In some embodiments, cluster assignments can be based on minimizing intra-cluster distances among clusters while maintaining cluster coverage of samples. As will be further described herein, the cluster assignments can be subsequently used for data contribution in the reconstruction step (block 106) whereby the data associated within each cluster either fully or partially can be assumed to reflect one phase (e.g., cardiac phase) in the physiological process. In various embodiments, the use of the cluster matrix facilitates a smoother transition between dynamic motion states regardless of the rhythm (e.g., cardiac rhythm). Furthermore, this feature can enable the presently disclosed technique for resolving motion to be iteratively adapted (e.g., by accounting for new or unresolved k-space data, new or unresolved phases, etc.).

In some embodiments, a regularization can be imposed on the plurality of clusters to provide a flexible mechanism for integration of varying motion patterns (e.g., cardiac motion patterns) of the physiological process and sequential temporal ordering. The optimization-driven adaptive scheme can thus provide a framework to handle both periodic and nonperiodic cardiac motion patterns.

In at least one embodiment, DRACO includes determining or generating a cluster matrix describing the time phase association between various navigation data and clusters as a cluster matrix M. The cluster matrix M can be of size K×T such that its (k,t)^{th} component can describe the likelihood and corresponding level of contribution of the sampled data at time t to the phase k (e.g., cardiac phase k). Each phase can be represented as a cluster centroid. The associations (e.g., probabilities) provided in cluster M and cluster configurations can be achieved by minimizing a cost function. The cost function can include but is not limited to: (1) a data fidelity term that reflects a strength of fit between observed data and the clusters, (2) a regularization term to encourage piecewise smoothness during motion state transitions (e.g., cardiac motion state transitions) that relate to the underlying rhythm (e.g., cardiac rhythm, such as but not limited to atrial fibrillation or premature ventricular contractions), and (3) a regularization term to encourage adjacency and intrinsic ordering of the clustering centers for smooth cluster transitions. In some aspects, the similarity term in the DRACO method imposes motion state adjacent clusters to be closer to each other.

Various embodiments for the adaptive and dynamic resolution of motion in imaging can further include image reconstruction (block 106) based on the cluster matrix and the image data. Although normal physiological processes can be characterized as regular and periodic rhythms (e.g., sinus rhythms in cardiac motions), abnormal physiological processes (e.g., arrhythmias) can have a variable rhythm. For example, the pattern of cardiac motion can vary with the duration of the RR interval, which reflects the cycle length for each heartbeat. In some instances, the RR interval is so short that only a few cardiac phases (motion states) exist. The presently disclosed technique includes a reconstruction of images to account for all received image data, including image data revealing periodic and non-periodic rhythms.

In the reconstruction (block 106), the time-cluster association matrix M can be used to generate images from uncertain motion patterns of the non-regular rhythms (e.g., arrhythmias) of the physiological process. The reconstructed images can result from minimizing a cost function that includes terms to enforce fidelity of the k-space data and spatial and/or temporal regularization (e.g., smoothness regularization). The K-space data fidelity can be enforced by taking into account multiple factors, including but not limited to under-sampling, coil sensitivity maps, Fourier transform, spatial encoding, and the cluster matrix, M. For example, the cluster matrix M can govern how k-space data from different cardiac cycles are softly combined at each time point to render the corresponding images. In some embodiments, the weight parameter λ can be used in the regularization term (e.g., smoothness regularization term) and can reflect the balance between k-space data fidelity and the dynamic motion states (e.g., dynamic cardiac motion states) of the physiological process. In some embodiments, the parameter λ can be further adjusted based on the patient for which the image is being reconstructed.

In some embodiments, reconstructing the image can involve generating an image data stream and/or a pseudo “real-time” video in which the clusters are visualized according to their ordering during the acquisition. In some embodiments, when generating the pseudo “real-time” videos, the cluster having the largest cluster value at each time point can be the one responsible for the image at that specific time point. Through an iterative process for each time point, a pseudo “real-time” video consisting of images from I can be produced.

### VI. Non-Limiting Exemplary Computer Implemented System

In various embodiments, the systems and methods for dynamically and adaptively resolving motion in imaging, including non-periodic and irregular motion, can be implemented via computer software or hardware.

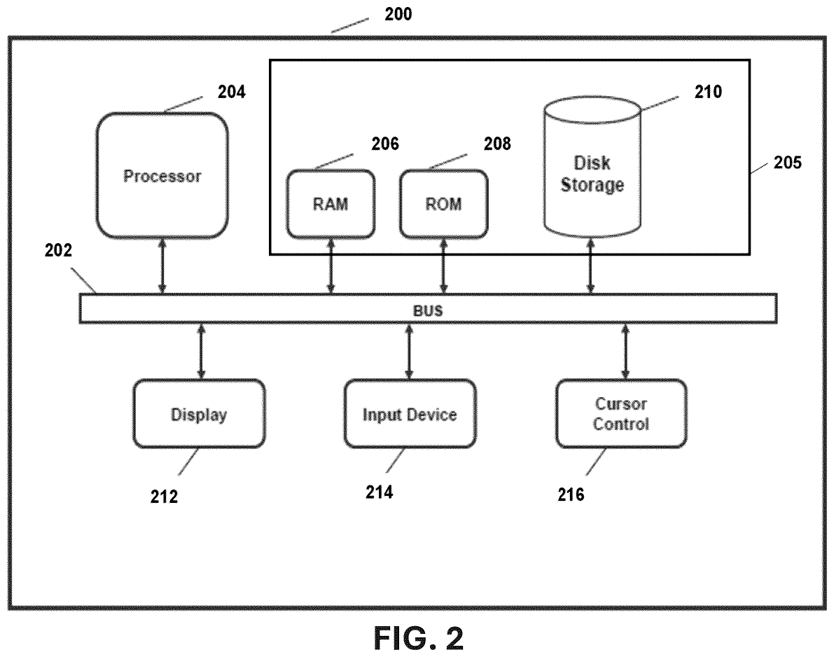

FIG. 2 is a block diagram illustrating a computing device 200 (also referred to herein as “computing system” or “computer device”) upon which embodiments of the present teachings can be implemented. In various embodiments of the present teachings, computing device 200 can include a bus 202 or other communication mechanism for communicating information and a processor 204 coupled with bus 202 for processing information. In various embodiments, computing device 200 can also include a memory 205, which can be a random-access memory (RAM) 206 or other dynamic storage device, coupled to bus 202 for determining instructions to be executed by processor 204. Memory can also be used for storing temporary variables or other intermediate information during execution of instructions to be executed by processor 204. In various embodiments, computing device 200 can further include a read only memory (ROM) 208 or other static storage device coupled to bus 202 for storing static information and instructions for processor 204. A storage device 210, such as a magnetic disk or optical disk, can be provided and coupled to bus 202 for storing information and instructions. In some embodiments (e.g., as shown in FIG. 2), the memory 205 can include any one or more of or all of the RAM 206, ROM 208, and storage device 210.

In various embodiments, computing device 200 can be coupled via bus 202 to a display 212, such as a cathode ray tube (CRT) or liquid crystal display (LCD), for displaying information to a computer user. In some embodiments, the display 212 can enable user input (e.g., via a touchscreen). An input device 214, including alphanumeric and other keys, can also enable the same and can be coupled to bus 202 for communication of information and command selections to processor 304. Another type of user input device is a cursor control 216, such as a mouse, a trackball or cursor direction keys for communicating direction information and command selections to processor 204 and for controlling cursor movement on display 212. This input device 214 typically has two degrees of freedom in two axes, a first axis (i.e., x) and a second axis (i.e., y), that allows the device to specify positions in a plane. Input devices 214 allowing for 3-dimensional (x, y and z) cursor movement are also contemplated herein.

In some embodiments, the display 212, the input device 214, and/or the cursor control 216 can enable a user (e.g., medical personnel, a researcher) to enter, for example, commands to view a reconstructed images and/or image data stream of a physiological process having motion. Consistent with certain implementations of the present teachings, results can be provided by computing device 200 in response to processor 204 executing one or more sequences of one or more instructions (e.g., computer executable instructions) contained in memory 206. For example, such instructions can include receiving image slices of a region of interest (ROI) of a patient acquired via an imaging modality; receiving, determining, and/or generating image data (e.g., k-spaces) and navigation data; determining or generating a cluster matrix via a clustering model; applying regularization; and/or reconstructing images or image data stream of the ROI to depict the physiological process characterized by motion (e.g., irregular and/or non-periodic motion). Such instructions can be read into memory 206 from another computer-readable medium or computer-readable storage medium, such as storage device 210. Execution of the sequences of instructions contained in memory 206 can cause processor 204 to perform the processes described herein. Alternatively, hard-wired circuitry can be used in place of or in combination with software instructions to implement the present teachings. Thus, implementations of the present teachings are not limited to any specific combination of hardware circuitry and software.

The term “computer-readable medium” (e.g., data store, data storage, etc.), “computer-readable storage medium,” “non-transitory computer-readable medium,” or “non-transitory computer-readable storage medium” as used herein, refers to any non-transitory media that participates in providing instructions to processor 204 for execution. Such a medium can take many forms, including but not limited to, non-volatile media, volatile media, and transmission media. Examples of non-volatile media can include, but are not limited to, dynamic memory, such as memory 206. Examples of transmission media can include, but are not limited to, coaxial cables, copper wire, and fiber optics, including the wires that comprise bus 202, as well as wireless communication networks.

Common forms of computer-readable media include, for example, a flexible disk, hard disk, a magnetic tape or any other magnetic medium, an optical medium, pa RAM, PROM, EPROM, EEPROM, a FLASH-EPROM, register memory, FLASH memory devices (e.g., NAND Flash, NOR Flash, etc.), another memory chip or cartridge, or any other tangible medium from which a computer can read. Additionally, the operations of a method or algorithm can reside as one or any combination or set of codes and instructions on a machine readable medium and computer-readable medium, which can be incorporated into a computer program product.

In addition to computer-readable medium, instructions or data can be provided as signals on transmission media included in a communications apparatus or system to provide sequences of one or more instructions to processor 204 of computing device 200 for execution. For example, a communication apparatus can include a transceiver having signals indicative of instructions and data. The instructions and data are configured to cause one or more processors to implement the functions outlined in the disclosure herein. Representative examples of data communications transmission connections can include, but are not limited to, telephone modem connections, wide area networks (WAN), local area networks (LAN), infrared data connections, NFC connections, etc.

It should be appreciated that the methodologies described herein, flow charts, diagrams and accompanying disclosure can be implemented using computing device 200 as a standalone device or on a distributed network or shared computer processing resources such as a cloud computing network.

The methodologies described herein can be implemented by various means depending upon the application. For example, these methodologies can be implemented in hardware, firmware, software, or any combination thereof. For a hardware implementation, the processing unit can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

In various embodiments, the methods of the present teachings can be implemented as firmware and/or a software program and applications written in conventional programming languages such as C, C++, Python, etc. If implemented as firmware and/or software, the embodiments described herein can be implemented on a non-transitory computer-readable medium in which a program is stored for causing a computer to perform the methods described above. It should be understood that the various engines described herein can be provided on a computer system, such as computing device 200, whereby processor 204 would execute the analyses and determinations provided by these engines, subject to instructions provided by any one of, or a combination of, memory components 206/208/210 and user input.

### VII. Non-Limiting Exemplary Computer Implemented Methods

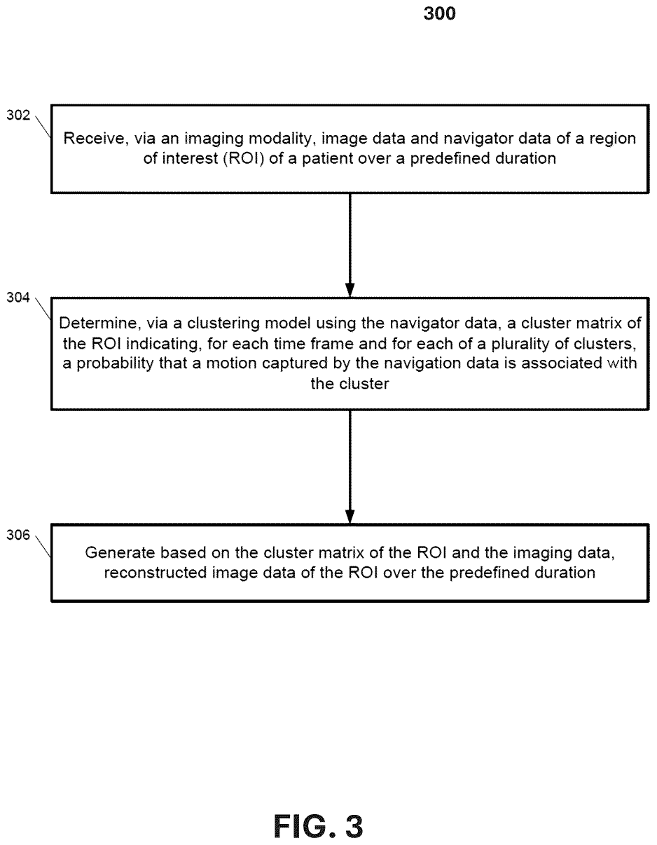

FIG. 3 is a block diagram illustrating an example computer-implemented method 300 for dynamically and adaptively resolving motion in imaging according to non-limiting embodiments of the present disclosure. The motion can include non-periodic and irregular motion. One or more blocks or processes described in the blocks of FIG. 3 can be performed by one or more computing devices (e.g., computing device 200). For example, the one or more blocks or processes can be performed by the processor 204 of computing device 200 based on instructions provided by the memory 205 or by any one of, or a combination of memory components 206/208/210 and user input (e.g., provided via the input device 214), as will be discussed herein.

In various embodiments, method 300 can begin at block 302 with a computing device (e.g., processor 204 of computing device 200) receiving image data and navigator data of a region of interest (ROI) of a patient over a predefined duration. In some embodiments, the image data can be received via an imaging modality, such as but not limited to magnetic resonance imaging (MRI), a computerized tomography (CT), an ultrasound, an electrocardiogram, and the like. For example, the imaging modality can be used to acquire or capture a plurality of image slides of the ROI of the patient where a physiological process involving motion occurs over the predefined duration. The ROI of the patient over the predefined duration can exhibit irregular and/or non-periodic motion. For a physiological process such as cardiac motion, the image slices can be acquired while the patient is holding breath during the predefined duration, for example, to avoid noise caused by lung movement. However, in some embodiments, the patient need not hold breath during the acquisition of image slices. For example, in some embodiments, the ROI can include at least a cardiac region and a lung region of the patient, and the image data can be acquired from the patient while the patient is freely breathing. The image data can comprise data in the k-space. In some embodiments, the image data and the navigator data are acquired by the imaging modality based on a golden step pulse sequence. The navigator data can be based on samples of the acquired image data at different time points of the predefined duration that indicate motion. In some embodiments, the acquired image data or acquired image slices can be used to determine navigator data for the predefined duration.

At block 304, the computing device (e.g., via processor 204) can determine a cluster matrix of the ROI. The cluster matrix can indicate, for each time frame and for each of a plurality of clusters, a probability that a motion captured by the navigation data is associated with the cluster. The cluster matrix can be determined or generated via a clustering model using the navigator data. For example, a k-means clustering model can be applied to a compressed motion navigator matrix Y formed using the navigator data to assign, for each navigator datapoint, probabilities to various clusters based on a similarity of motion information from k-space navigator lines. In some embodiments, the cluster matrix can describe the time phase association between various navigation datapoints and clusters, such that each component of the matrix can describe the likelihood and corresponding level of contribution of the sampled data at any given timepoint to any given phase (e.g., a cardiac phase) of a plurality of phases of the physiological process. Each phase can be represented as a cluster centroid. The associations (e.g., probabilities) provided in the cluster matrix and cluster configurations can be achieved by minimizing a cost function. In some embodiments, determining the cluster matrix of the ROI includes identifying, based on the received image acquisition data, the plurality of clusters. In some aspects, the plurality of clusters, the number of navigation datapoints, and/or the probabilities assigned can be dynamically updated or adjusted.

At block 306, the computing device can generate based on the cluster matrix of the ROI and the image acquisition data, a reconstructed image data of the ROI. The reconstruction can be based on the probabilities indicated by the cluster matrix. For example, the image data can include one or more unresolved areas of the ROI. Generating the reconstructed image data can include determining, using the cluster matrix of the ROI, an order and a weight of each of the one or more unresolved areas of the ROI. In some embodiments, prior to generating the reconstructed image data, the processor can regularize a similarity between at least two clusters of the plurality of clusters, using the cluster matrix of the ROI of the patient. Also or alternatively, the processor can apply a regularization, such as total variation (TV) regularization, along a temporal dimension of the image data using the cluster matrix of the ROI. In some embodiments, the reconstructed image data can be based on the sensitivity map, which can be determined or generated based on the image data.

In describing the various embodiments, the specification can have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps can be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences can be varied and still remain within the spirit and scope of the various embodiments. Similarly, any of the various system embodiments may have been presented as a group of particular components. However, these systems should not be limited to the particular set of components, now their specific configuration, communication and physical orientation with respect to each other. One skilled in the art should readily appreciate that these components can have various configurations and physical orientations (e.g., wholly separate components, units and subunits of groups of components, different communication regimes between components).

Although specific embodiments and applications of the disclosure have been described in this specification, these embodiments and applications are exemplary only, and many variations are possible.

### EXAMPLES

These examples are provided for illustrative purposes only and not to limit the scope of the claims provided herein.

### Example 1. Materials and Methods

This Example provides an overview of the full methodological pipeline that forms the foundation of the disclosed methods and systems. The materials and methods established in this Example are applied throughout Examples 2-5 infra to demonstrate the performance and utility of the present disclosure across multiple evaluation settings.

### Data Acquisition and Preprocessing

With approval from the local Institutional Review Board and in compliance with the Health Insurance Portability and Accountability Act, 17 patients with arrhythmias (n=13 AF, n=4 premature ventricular contractions (PVC)) and 1 subject with sinus rhythm were recruited to undergo cardiac MRI. All participants provided written informed consent prior to participation. All AF and PVC patients had arrhythmias during the scan. All scans were performed on a 3.0 T clinical scanner (Skyra; Siemens Healthcare, Erlangen, Germany) with an 18-channel phased-array body coil. Using both the sorted Cartesian golden step sequence and a commercially available reference real-time sequence, 10-12 imaging slices in the ventricular short-axis orientation (covering the entire ventricle) were acquired. The reference real-time sequence had a Cartesian balanced steady-state free precession (bSSFP) readout and inline reconstruction provided by the commercial entity. Representative sequence parameters are shown in Table 1. The acquisitions were performed with breath-holding to minimize respiratory-motion related differences between the sorted Cartesian golden-step and the reference real time images. The ECG signal was simultaneously recorded during the data acquisition and used for timing in the DRACO algorithm. The sorted golden step sequence with additional navigators had been previously described. Briefly, additional k-space center lines were introduced after every nth TR to a free-running Cartesian sequence with sorted golden-step trajectory and bSSFP readout. The additional k-space center lines acted as motion navigators and were combined as one single matrix with dimension N_{coil}N_{enc}×T, where N_{coil} was the number of receive coils, N_{enc} was the number of data points in the frequency encoding direction, and T was the number of navigators along the time dimension. The Inverse Fast Fourier Transform was applied in the frequency encoding direction to convert frequency information to 1D spatial projections. The first order difference of the projections was calculated and the first order differences from multiple coils were concatenated to a new data matrix X with dimension N_{coil}N_{enc}×T. Principal component analysis was applied along the coil direction at each time point to generate a compact matrix y∈ [symbol] ^{N}^{_{features}}^{×T}, which can be used in either of the subsequent clustering algorithms.

TABLE 1
Representative pulse sequence parameters for sorted Cartesian
golden-step bSSFP and reference real-time at 3.0 T.

| | | Sorted Cartesian |
|---|---|---|
| | Real-time cine | golden-step |
| Parameter | bSSFP | bSSFP |
| FOV (mm²) | 380*285 | 380*285 |
| Spatial resolution (mm²) | 1.8*1.8 | 1.8*1.8 |
| Slice thickness (mm) | 8 | 8 |
| Flip angle (degrees) | 45-55 | 45-55 |
| Asymmetric echo factor | off | off |
| Partial Fourier factor | off | off |
| Parallel acceleration factor | off | off |
| TR (ms) | 3.1 | 3.4 |
| TE (ms) | 1.5 | 1.7 |
| Receiver bandwidth | 957 | 962 |
| (Hz /pixel) | | |
| ECG-trigger | No | No |
| Acquisition time per 2D slice | 9-20 (depending on | 18 (fixed) |
| (second) | arrhythmia rejection) | |

bSSFP, balanced steady-state free precession; ECG, electrocardiogram; FOV, field of view; TE, echo time; TR, repetition time

### Clustering of Cardiac Motion States

The k-means clustering approach for handling cardiac motion states had been previously described and was used in this work as a comparator to the proposed DRACO method. In brief, k-means clustering was applied to the compressed motion navigator matrix y and data points representing similar cardiac motion states were assigned to clusters based on similarity of motion information from k-space navigator lines. Navigator lines in the same cluster were considered to have similar motion. 25 clusters were chosen to yield a temporal resolution of ~40 msec, and cluster assignments were based on minimizing the sum of in-cluster distances among all clusters. The cluster assignments were used for data binning in the reconstruction step whereby the data within each cluster were assumed to reflect one cardiac phase.

In contrast to conventional clustering approaches, DRACO was designed to estimate probabilistic associations between k-space data at each time point and the intrinsic cardiac phase or time-phase association of mechanical cardiac motion states. This feature enabled depiction of a smooth transition between dynamic motion states regardless of the cardiac rhythm and enabled iterative adaptation. To provide a flexible mechanism for integration of varying cardiac motion patterns and sequential temporal ordering, regularization was imposed on the clustering geometry. Finally, the optimization-driven adaptive scheme provided a single framework to handle both periodic and nonperiodic cardiac motion patterns. This 3-prong approach provided a convenient and comprehensive way to represent both morphologic and physiological prior assumptions in a unified manner.

In brief, the time phase association was described as matrix M of size K×T such that its (k,t)th component described the likelihood and corresponding level of contribution of the sampled data at time t to the cardiac phase k. In the experimental setting, K was typically 25 and T was typically 1290. Each cardiac phase was represented as cluster centroids. The association [symbol] and cluster configurations were achieved by minimizing a cost function that included (1) a data fidelity term that reflected the goodness of fit between observed data and the clusters, (2) a regularization term that encouraged piecewise smoothness during cardiac motion state transitions that relates to the underlying cardiac rhythm such as AF or PVCs, and (3) a regularization term that encouraged adjacency and intrinsic ordering of the clustering centers for smooth cluster transition. Although others have used a more passive but causal way to impose closeness in time-resolved reconstruction, the similarity term in the DRACO method imposed motion state adjacent clusters to be closer to each other.

### Image Reconstruction

In sinus rhythm, cardiac motion was regular and periodic. However, in arrhythmias, the pattern of cardiac motion varied with the duration of the RR interval, which reflected the cycle length for each heartbeat. In some instances, the RR interval was so short that only a few cardiac phases (motion states) existed.

For the k-means approach, image reconstruction for sinus rhythm and arrhythmias was performed as previously described using the ESPIRiT reconstruction method. Briefly, ESPIRiT was applied to every cluster bin to generate the cine images. To generate a video of the reconstructed data, the temporal order for the patient with sinus rhythm was based on the recorded ECG. For patients with arrhythmias, the temporal order was generated based on the sequential time stamp from the navigator data such that images with a shorter time stamp were ordered earlier and images with longer time stamp were ordered later in the cardiac cycle.

For the proposed DRACO reconstruction step, the time-cluster association matrix [symbol] was employed to generate images from uncertain motion patterns during arrhythmias. The reconstructed images resulted from minimizing a cost function that included terms to enforce fidelity of the k-space data and total variation (TV) regularization. K-space data fidelity was enforced by taking into account under-sampling, coil sensitivity maps, Fourier transform, and [symbol] . The cluster matrix [symbol] governed how k-space data from different cardiac cycles were softly combined at each time point to render the corresponding images. The weight parameter/was used in the TV regularization term and reflected the balance between k-space data fidelity and dynamic cardiac motion states. The parameter A required fine-tuning for specific patient cohorts. In the current dataset, the best λ was either 0.0003 or 0.0005. When generating pseudo “real-time” videos, the cluster having the largest cluster value at each time point was the one responsible for the image at that specific time point. Through an iterative process for each time point, a pseudo “real-time” video consisting of images from I was produced.

For comparison purposes, real-time images were also reconstructed from the commercially available reference real-time pulse sequence acquisition. In the latter case, each phase of the real-time images was directly generated using the temporally adjacent k-space data.

### Assessment of Image Quality and Measure of Ventricular Function

To assess image quality, three readers independently graded the image quality using a 4-point Likert scale (Table 2). Images from DRACO, k-means, and reference real-time methods were randomized and shown to all readers, who were blinded to the methodology. Representative end-systolic(ES) and end-diastolic (ED) images in the left ventricular base, mid, and apical slices from all subjects (n=17) were scored first because the systolic and diastolic frames were most important for cardiac function analysis. Multiphase images of the ventricular base, mid, and apical slices were then scored in real-time cine mode. A total of 51 slices (17 patients×3 slices) at ES and at ED and cine videos (n=51) from the three methods were evaluated and compared.

TABLE 2
Image quality scoring criteria

| Score | Criteria |
|---|---|
| 1 - non diagnostic | Chambers not visualized or diagnostically not |
| | assessable due to motion artifact or poor contrast |
| 2 - diagnostic | Chambers distinguishable but cardiac borders are |
| | poorly defined, only gross features evaluable, cardiac |
| | motion related artifacts are present |
| 3 - good | Chambers clearly distinguishable with a well-defined |
| | septum and free wall, minimal cardiac motion-related |
| | artifacts are present |
| 4 - excellent | Chambers clearly distinguishable with excellent |
| | cardiac border definition, clear visualization of thin |
| | structures such as valves and trabeculation, |
| | homogenous blood pool |

Quantitative image quality metrics including signal-to-noise ratio (SNR), contrast-to-noise ratio (CNR), and edge sharpness were also compared. To calculate SNR, regions of interest were drawn (ZM, 5 year of cardiac MR experience) within the mid-ventricular blood pool, myocardium, and air (outside the body but within the field of view). Mean signal intensity (SI) was recorded in blood and myocardium, and the standard deviation (SD) of the SI was assessed in air to quantify image noise. The SNR of all tissue types was calculated as:

$$SNR = \frac{mean ( {SI}_{tissue} )}{SD ( {SI}_{air} )}$$

The CNR between blood and myocardium was computed as:

$$CNR = \frac{{SI}_{b lood} - {SI}_{myocardium}}{SD ( {SI}_{air} )}$$

To assess the relative impact of DRACO vs k-means on image noise, the corresponding SNR and CNR ratios were computed for DRACO and k-means reconstruction (Equations 1-2):

$$SNR ratio = \frac{{DRACO}_{S N R}}{k {means}_{S N R}} \qquad ( Equation 1 )$$

$$CNR ratio = \frac{{DRACO}_{C N R}}{k {means}_{C N R}} \qquad ( Equation 2 )$$

To compare the edge sharpness of images generated from the DRACO and k-means methods, a signal intensity profile was plotted along a line across the right ventricle (RV), interventricular septum, and left ventricle (LV) of the ES and ED mid-ventricular images. The slope between the 25^{th} and 75^{th} percentile of the intensity values at the blood pool and interventricular septal edges was computed. The average slope values in

$$\frac{1}{pixel}$$

from the ES and ED images were used to compare the edge sharpness between the two methods. A larger average slope value represents sharper edges.

In AF, significant beat-to-beat variation in ventricular function existed and the effect of the RR intervals on LV ejection fraction (EF) was more pronounced than in sinus rhythm. Notably, the cycle length of the preceding RR interval had been shown to be related to the stroke volume and in AF, the effect of the preceding RR interval on LV stroke volume was strongest at higher heart rates. Therefore, to evaluate ventricular function derived from DRACO, the relationship between the preceding RR intervals and the LV area changes in the mid ventricular slices were analyzed. Specifically, curves of LV area change over time for the mid-ventricular slice of each patient were generated from the DRACO-reconstructed “real-time” videos. The maximum and minimum ventricular areas were identified for each curve and the LV area change reflected the difference between the maximum and minimum LV area over multiple heartbeats. A regression analysis was then performed between the preceding RR interval and the LV area change.

For both the DRACO and reference real-time images, commercially available software (Medis Suite 4.0, Medis Medical Imaging, Leiden, Netherlands) was used to quantify EF, end-diastolic volume (EDV), end-systolic volume (ESV) of the RV and LV as well as LV mass from a full stack of 10-12 ventricular short-axis slices. DRACO-reconstructed images had 25 phases per slice. The ventricular volumes and EFs were calculated by averaging diastolic and systolic volumes across three consecutive heartbeats.

### Statistical Analysis

Statistical analysis was performed using MATLAB version 2021a (MathWorks, Natick, MA, USA). Categorical variables were summarized as frequencies or percentages. Continuous variables were summarized as mean±SD or median and interquartile range as appropriate. The Kolmogorov-Smirnov test was used to test normality of the data. For group comparisons, a two-tailed paired sample t-test was performed on normally distributed data. The Friedman test was performed for multiple nonparametric image quality score comparisons (DRACO method, k-means method, and reference method) with subsequent post-hoc group analysis using Tukey's test. Inter-reader agreement of image scoring was calculated using Fleiss' Kappa. Fleiss' Kappa value is interpreted as: ≤0 no agreement, 0.01-0.20 slight agreement, 0.21-0.40 fair agreement, 0.41-0.60 moderate agreement, 0.61-0.80 substantial agreement, and 0.81-1.00 almost perfect agreement. Two group comparisons were performed with the Wilcoxon rank sum rest. Linear regression analysis was performed to evaluate ventricular function using the preceding RR intervals and LV area change curves. A P value of <0.05 was considered statistically significant. Bland-Altman analyses were applied to assess the mean bias for biventricular EDV, ESV, and EF values derived from the DRACO approach and the reference real-time approach.

### Theory for DRACO Algorithm

[symbol] ∈

$${ℝ}_{\geq 0}^{K \times T}$$

was let to be a nonnegative membership matrix with columns in a probability simplex, where K was the number of cardiac phases and T was the number of time points. Each column mₜ indicated the association of the sample at time point t with the K phases respectively. Cluster centroids were represented by matrix [symbol] ∈ [symbol] ^{N}^{_{features}}^{×K}, where each column represented one cluster centroid.

The association of k-space data to clusters (membership in [symbol] ) and the cluster centers [symbol] were jointly estimated by minimizing the objective in Equation 3:

$$Φ ( ℳ , 𝒞 ) = {\underbrace{{\sum }_{t = 1}^{T} {\sum }_{k = 1}^{K} {ℳ}_{kt} {‖ {y}_{𝔱} - {c}_{k} ‖}^{2}}}_{goodness of fit} + {λ}_{ℳ} {\underbrace{{\sum }_{t = 1}^{T} ‖ {m}_{t} - {m}_{t - 1} ‖}}_{piecewise smooth state transitoin} + {λ}_{𝒞} {\underbrace{{\sum }_{k = 1}^{K} {‖ {c}_{k} - {c}_{k - 1} ‖}^{2}}}_{smooth cluster transition} \qquad ( Equation 3 )$$

$$s . t . {ℳ}_{kt} \geq 0 , {\sum }_{k = 1}^{K} {ℳ}_{kt} = 1 , ∀ t$$

where ∥⋅∥ indicated Euclidean norm. yₜ= [symbol] (:, t)∈ [symbol] ^{N}^{_{features}} was the observation at time t and cₖ= [symbol] (:, k)∈ [symbol] ^{N} was the centroid of cluster k (k ranges from 1 to K). λ_{M} and λ [symbol] were the weighting coefficients of the regularization terms.

The first term reflected the association-weighted fidelity of the data to the cluster centers. The second term was the total variation (TV) of membership along the time dimension to encourage piecewise, smooth cluster transition. The third term constrained the cluster centers in adjacent phases to be close for the purpose of rendering a natural ordering of the clusters.

### Image Reconstruction for DRACO

To generate images from uncertain motion patterns during arrhythmias, the clustering membership matrix [symbol] was employed in the reconstruction step, as described in Equation 4:

$$I = arg {min}_{I} {\underbrace{‖ ( Ω ( {FSI}_{K} ) - Z ) ℳ {‖}_{2}^{2}}}_{fidelity to k - space data} + λ {\underbrace{{‖ I ℳ {D}_{t} ‖}_{1}}}_{TV for temporal smoothness} \qquad ( Equation 4 )$$

Where I_{K} contained the reconstructed images of the K clusters; Ω and F represented under-sampling and Fourier transform operators respectively; S contained the sensitivity maps estimated using ESPIRiT; Z is the k-space data; Dₜ was the finite difference operator along time; and λ was the coefficient of the TV regularization of the reconstruction. The cluster matrix [symbol] governed how k-space data from different cardiac cycles were softly combined at each time point to render the corresponding image. When generating “real-time” videos, the cluster having the largest cluster value at each time point was the one responsible for the image at that specific time point. Through an iterative process for each time point, a “real-time” video consisting of images from I_{K} was produced.

In addition, a temporal self-correlation matrix of [symbol] was applied to visualize temporal irregularity of cardiac motion. For [symbol] with dimension K×T, the temporal self-correlation matrix was calculated by the transpose of [symbol] multiplied by [symbol] . Thus, the value on the i^{th} row and j^{th} column of self-correlation matrix represented the similarity between the i^{th} column of [symbol] of and j^{th} column of [symbol] . Large value showed high similarity. If cardiac motion was perfectly periodic and had a period t₁, then the i^{th} column of [symbol] and the (i+t₁)^{th} column of [symbol] was always the same, and their similarity was 1. The result was one diagonal line consisting of 1 in the self-correlation matrix. Multiple diagonal lines were generated by changing t₁ to 2t₁, 3t₁, 4t₁ and so on. Finally, the self-correlation matrix of perfectly periodic [symbol] (such as sinus rhythm) contained multiple parallel diagonal lines consisting of 1. The lack or absence of multiple diagonal lines in the self-correlation matrix indicated nonperiodic cardiac motion. Multiple diagonal lines with different spacing in between represented changes in instantaneous rate.

### Example 2. Illustrations of Qualitative Performance on Clustering Behavior

Seventeen subjects with arrhythmias (68±14 years, n=17 males, n=13 atrial fibrillation, n=4 PVCs) and one subject (53 years, female) in sinus rhythm underwent imaging at 3.0 T. The average heart rate was 71±23 BPM.

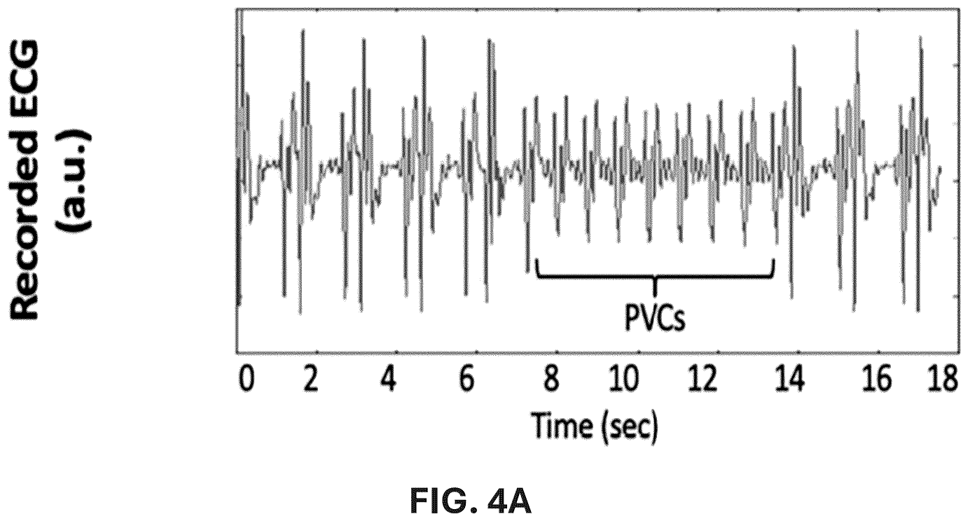

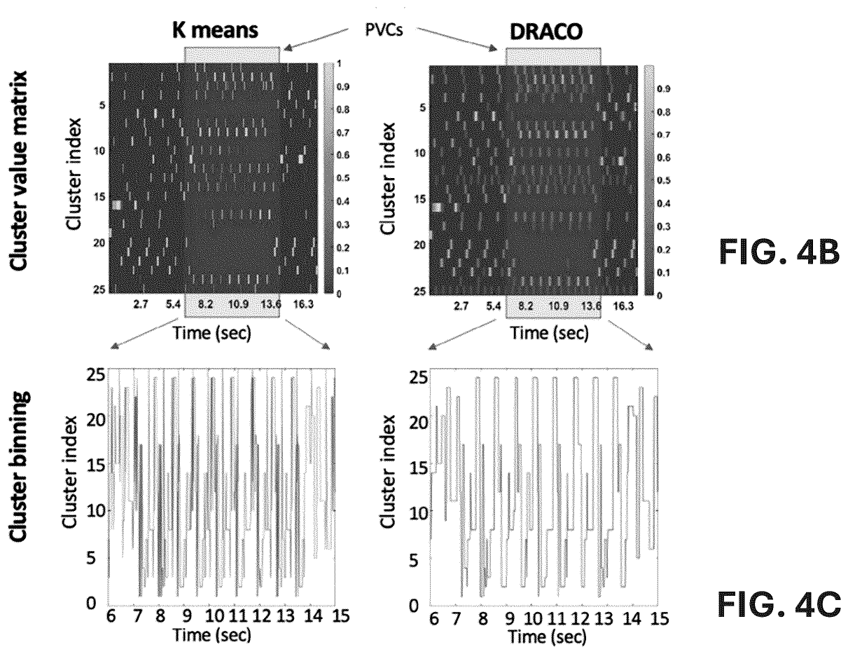

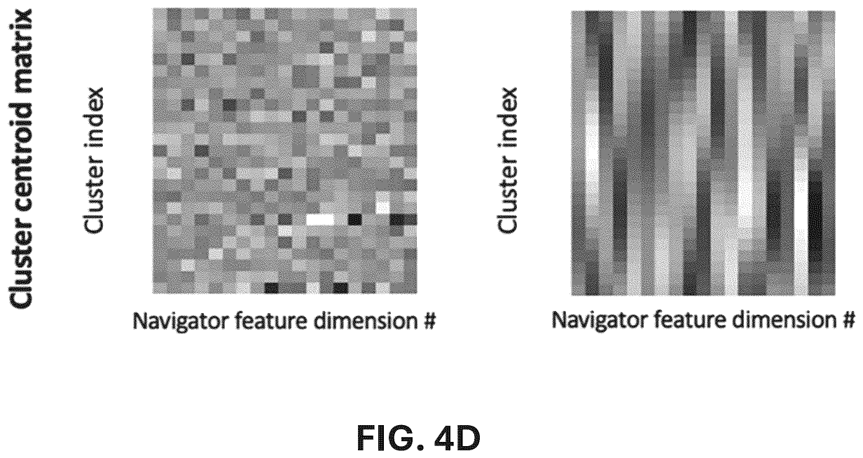

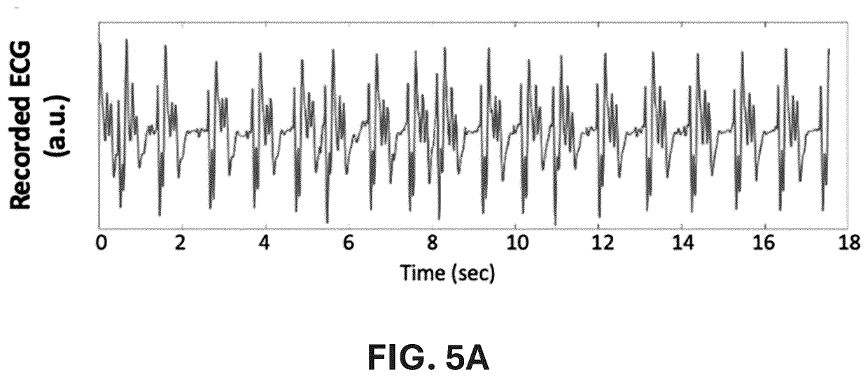

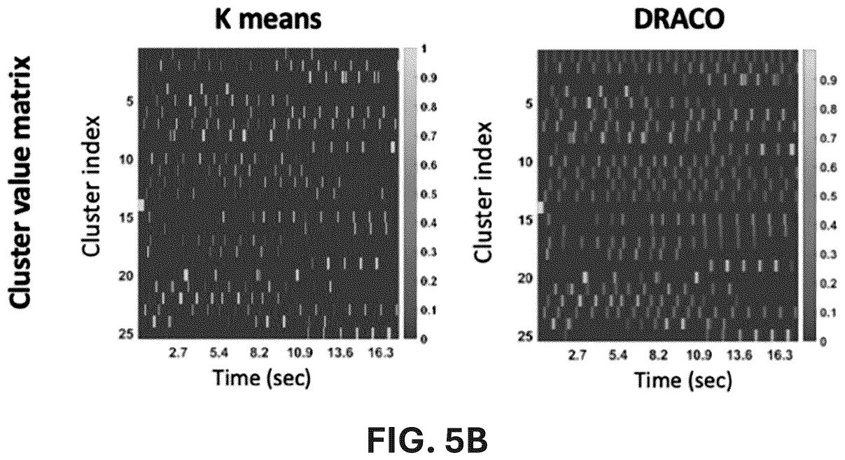

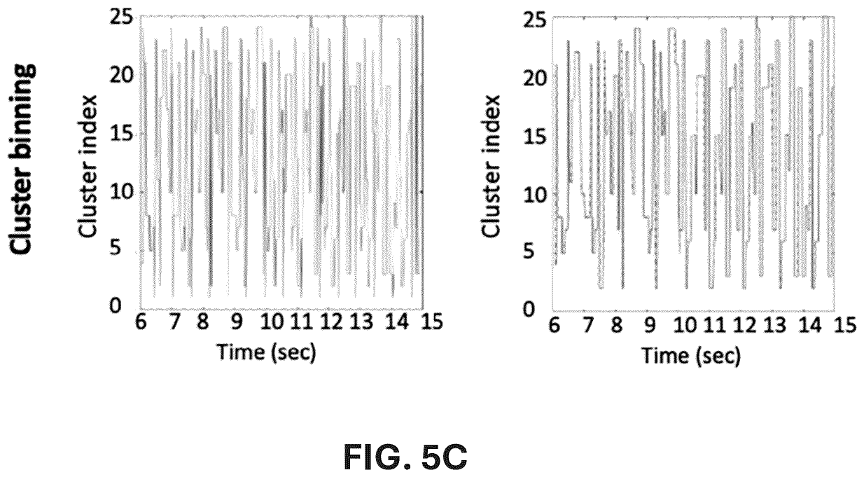

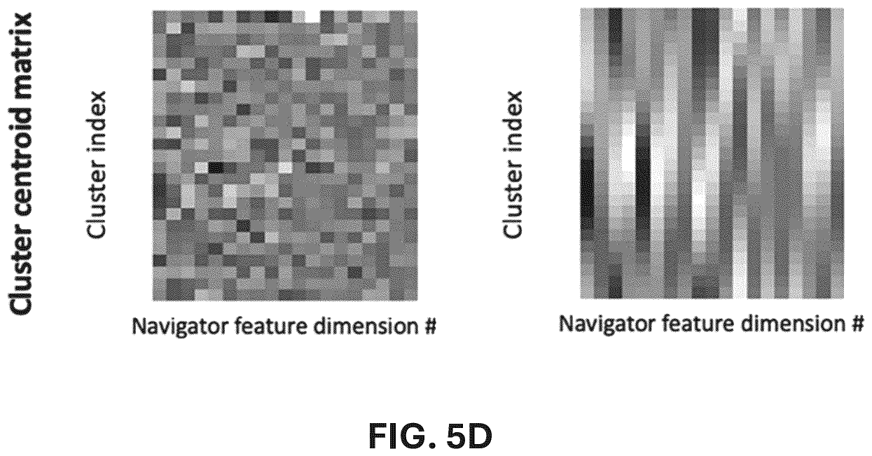

Data collected from a patient with a run of premature ventricular contractions (PVCs) and from a patient with atrial fibrillation during image acquisition were analyzed (FIGS. 4A-4D, 5A-5D). For the cluster value similarity matrices, the y-axis indicated the cluster index number and the color scale indicated similarity values for the data points within the cluster. A similarity value of zero represented no similarity, whereas a value of one represented 100% similarity.

In the setting of PVCs (FIGS. 4A-4D), a brief, continuous period non-sustained ventricular tachycardia was seen in the middle while longer periods at the beginning and the end corresponded to sinus rhythm seen on the simultaneously recorded ECG signal (FIG. 4A).

Two different motion patterns were appreciated in the illustrations of the cluster value similarity matrix (FIG. 4B) and cluster binning (FIG. 4C). Cluster value similarity matrices showed that DRACO can deal with the variation in motion patterns including shifts between abnormal heartbeats (PVC run) and normal heartbeats (sinus beats) (FIG. 4B). Both cluster matrices for k-means and DRACO showed different temporal patterns during sinus and during the PVCs. However, the results for DRACO showed more variation in the similarity values across the clusters at each time point than k-means, which fit well with the shift in periodicity shown in the section of the ECG recording with PVCs.

Apparent in the clustering binning results (FIG. 4C), DRACO was more effective at suppressing abrupt changes during binning than k-means. DRACO successfully reduced abrupt temporal changes that sometimes occurred during cluster binning. The separation of motion states along the x-axis was more well-defined for DRACO. Unlike the abrupt patterns seen for k-means, locations of adjacent clusters were also more continuous in the DRACO cluster centroid matrix (FIG. 4D). Relative to k-means, the cluster centroid matrix for DRACO showed improved continuity of cluster positions, which was beneficial for subsequent image reconstruction. In contrast, the centroid values of k-means show a noise-like pattern along the cluster index dimension. The cluster centroid values for DRACO have a smooth shift along this dimension. These differences in the behavior or performance reflected intrinsic differences between k-means clustering and the proposed DRACO method. In k-means clustering, the cost function contained only the data fidelity term. In contrast, DRACO had two additional regularization terms that enforced smoothness of motion state transitions and smoothness in cluster transitions. The [symbol] in k-means was a matrix with a binary value (0 or 1), whereas DRACO had a probability-like matrix. Moreover, the DRACO reconstruction included a temporal TV regularization term, whereas the k-means method used ESPIRiT reconstruction without TV regularization. These features contributed to the better performance of the DRACO approach relative to k-means.

For the patient with atrial fibrillation, variations in the RR interval were clearly observed on the recorded ECG (FIG. 5A). Cluster value similarity matrices showed that DRACO can handle the time-varying motion patterns that were intrinsic to atrial fibrillation. There was a wider range of similarity scores across the clusters generated from DRACO (FIG. 5B). Cluster binning results showed that DRACO can suppress abrupt changes during binning (FIG. 5C). Relative to k-means, DRACO showed better disaggregation of cluster index values (FIG. 5B), and DRACO cluster binning (FIG. 5C) suppressed the abrupt temporal changes while achieving temporal sensitivity that captured the irregular cardiac motion inherent to atrial fibrillation. The continuity of adjacent clusters in the DRACO centroid matrix (FIG. 5D) was also consistent with the premise that the regularization step for the current atrial fibrillation dataset should be cluster-continuous. Relative to k-means, the cluster centroid for DRACO showed improved continuity of cluster positions in the setting of varying RR intervals, which was beneficial for subsequent image reconstruction. The cluster centroid values for k-means showed an abrupt, pixelated, and noisy pattern along the cluster index dimension. In contrast, the cluster centroid values from the DRACO method had smooth shifts along the cluster dimension.

The performance of the DRACO method to better distribute the high values along the time dimension relative to k-means were notable (FIGS. 4A-4D and 5A-5D). Unlike the k-means approach which defined cluster membership in a binary fashion, the probability-like matrix [symbol] in DRACO facilitated a probability distribution of motion states that was more akin to the underlying cardiac rhythm.

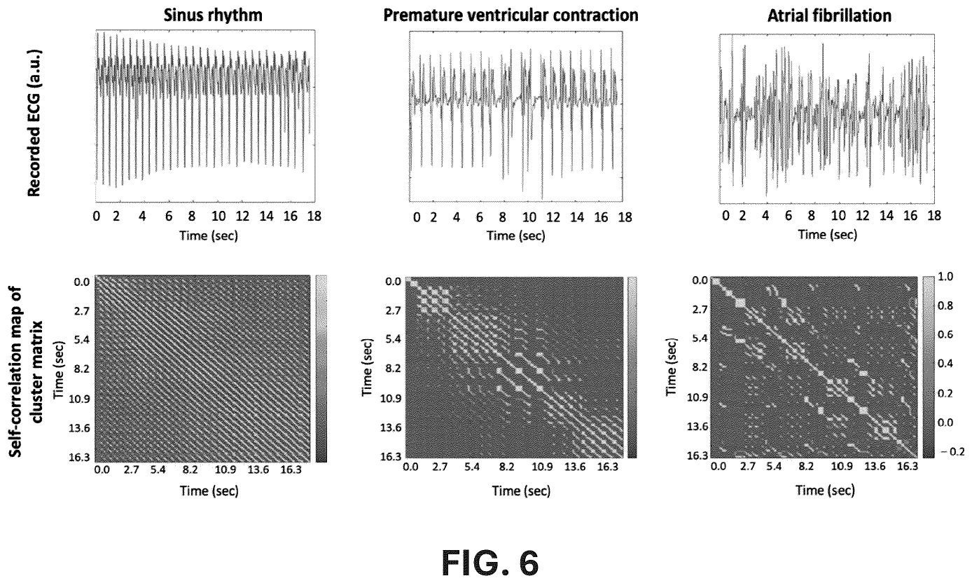

Recorded ECG and corresponding self-correlation maps of the cluster matrix for sinus rhythm, PVCs, and atrial fibrillation were analyzed (FIG. 6). The self-correlation maps illustrated the behavior of the cluster matrix and their correlation over time. The self-correlation map for sinus rhythm showed repetitive and highly correlative values as a result of periodic cardiac motion, as illustrated by dense yellow parallel lines. In the setting of PVCs, multiple yellow parallel and diagonal lines were also present on the self-correlation map, but these lines were less dense than those for sinus rhythm showing that cardiac motion remained relatively periodic, but less so. The time points were still highly correlated with each other and the motion of these PVCs maintained a specific degree of periodicity. In this example, between 8 to 11 secs, there were several separate diagonal lines with larger gaps between each other. This suggested that the motion pattern between 8-11 secs was different from that at other time points, but that the motion remained quasiperiodic within that 8-11 sec period. In the correlation map for atrial fibrillation, there were almost no sub-diagonal lines, which was consistent with the inherent irregular, nonperiodic nature of cardiac motion of atrial fibrillation.

### Example 3. Image Quality, SNR, CNR, and Edge Sharpness

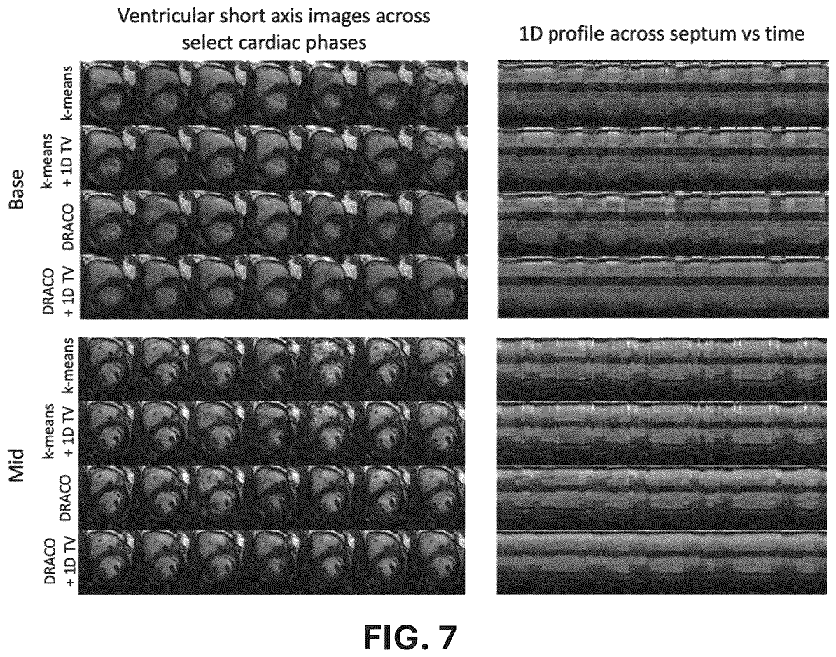

As shown in a summary of the qualitative and quantitative results (Table 3), there were significant differences in the quality of single-phase images among the methods. Based on a 4-point Likert scale, DRACO had a higher percentage of single-phase (diastolic, systolic) images with image quality score ≥3 relative to k-means and reference real-time cine. A significant difference was found between single-phase image quality scores for DRACO vs k-means and for DRACO vs reference real-time (Friedman test, all p values <0.001). The systolic and diastolic single-phase images generated by DRACO had no severe image artifacts. It was shown that DRACO+1D TV was able to generate excellent quality images whereas those reconstructed by k-means have some artifacts (FIG. 7). The 1D profiles of images that were generated using DRACO+1D TV showed continuous shape change, while the 1D profiles of those from k-means showed abrupt changes over time.

TABLE 3
Summary of quantitative and qualitative metrics

| Methods | DRACO | k-means | Real-time |
|---|---|---|---|
| SNR | 137.2 ± 91.6 | 70.1 ± 48.0 | NA |
| CNR | 92.2 ± 59.5 | 47.1 ± 28.9 | NA |
| Edge sharpness (pixel⁻¹) | 1.01 ± 0.62 | 0.71 ± 0.45 | NA |
| Image score: diastole | 3.72 ± 0.50 | 3.21 ± 0.82 | 3.16 ± 0.84 |
| Image score: systole | 3.64 ± 0.54 | 3.13 ± 0.70 | 3.03 ± 0.80 |
| Image score: multi-phase | 3.61 ± 0.52 | 2.38 ± 0.58 | 2.94 ± 0.79 |
| Percent of images with | 96 | 73 | 70 |
| quality scores ≥3: diastole | | | |
| (%), N = 51 | | | |
| Percent of images with | 93 | 73 | 66 |
| quality scores ≥3: systole | | | |
| (%), N = 51 | | | |
| Percent of images with | 93 | 27 | 62 |
| quality scores ≥3: multi- | | | |
| phase (%), N = 51 | | | |

CNR, contrast-to-noise ratio; NA, not applicable; SNR, signal-to-contrast ratio

There were significant differences in the quality of multi-phase cine images among methods. For cine images generated by DRACO, a total of 93% received a score of ≥3, compared to 27% for k-means and 62% for the reference real-time method. A significant difference was also found between multiphase image quality scores for DRACO vs k-means and for DRACO vs reference real-time. Illustrative cine video examples of the case showed that DRACO reduced the flickering artifacts that typically degraded the images generated by k-means (FIG. 7). The video file can be found at onlinelibrary.wiley.com/doi/10.1002/jmri.29425 (see VideoS1 in Supporting Information). Inter-reader agreement analysis of image quality scores was moderate (Fleiss' kappa values of 0.57 for diastolic phase, 0.51 for systolic phase, and 0.43 for multiphase images).

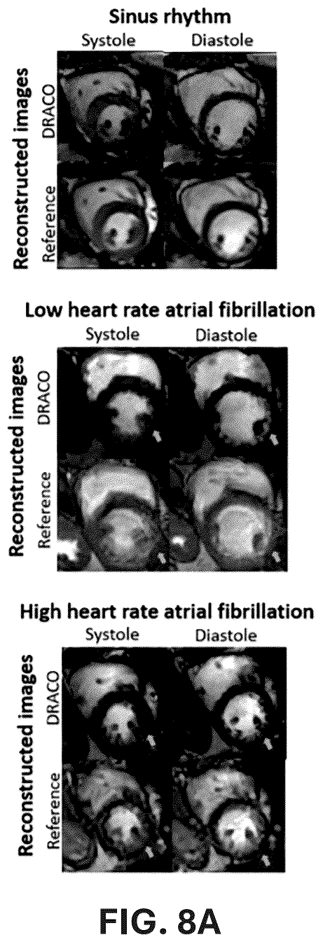

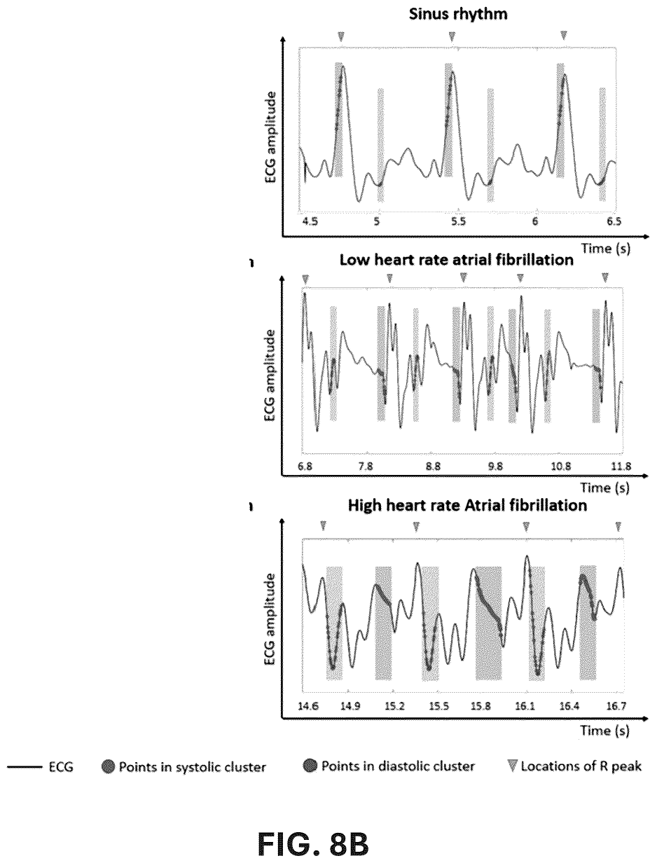

DRACO and real time images from a subject with sinus rhythm and two patients with atrial fibrillation were analyzed (FIGS. 8A-8B). One patient with atrial fibrillation had a low average heart rate (~45 BPM) and the other had a higher average heart rate (~95 BPM). It was observed in cine videos of the corresponding subjects that DRACO generated diastolic and systolic images with almost no artifacts in all three subjects (FIG. 8A), whereas some artifacts were present on the reference real-time images, particularly the systolic images from the subjects with atrial fibrillation. The video file can be found at onlinelibrary.wiley.com/doi/10.1002/jmri.29425 (see VideoS2 in Supporting Information). Without prior information from the ECG signals, DRACO consistently clustered the data points immediately before the R peak within one cluster (diastole) and data points immediately after the R peak in another cluster (systole) regardless of the differences in the QRS morphology (FIG. 8B).

The ratio of the DRACO SNR to that of the k-means SNR was 1.97±1.23. The ratio of the DRACO CNR to that of the k-means CNR was 2.07±1.31. Paired t-tests found significant differences in the SNR and CNR values for DRACO vs k-means. The edge sharpness was higher (1.01±0.62 pixel⁻¹) for DRACO than for k-means (0.71±0.45 pixel⁻¹ for k-means (paired t-tests, p=0.052, 95% confidence interval [0.003, 0.566])

### Example 4. LV Area Change Vs. Preceding RR Interval as a Marker of Ventricular Function

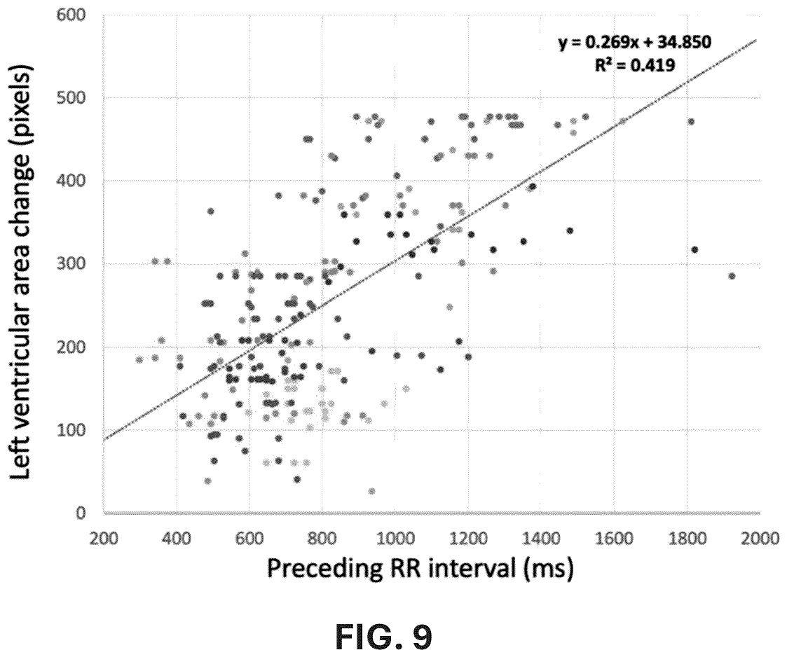

A regression analysis of the LV area change vs preceding RR interval showed a nonlinear relationship between LV area change and the preceding RR interval (R² of 0.419, p<0.05) (FIG. 9). The correlation coefficient between left ventricular area change and preceding RR interval was 0.647.

### Example 5. Bland-Alman Analyses of Cardiac Function Derived from DRACO and Real-Time

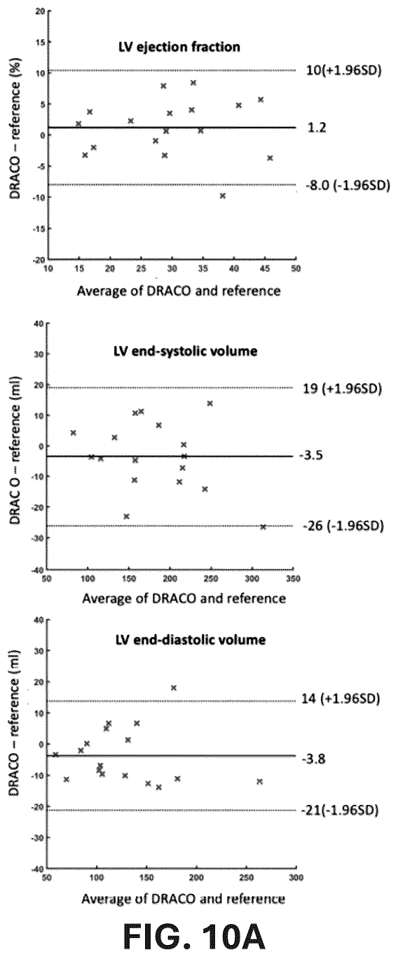

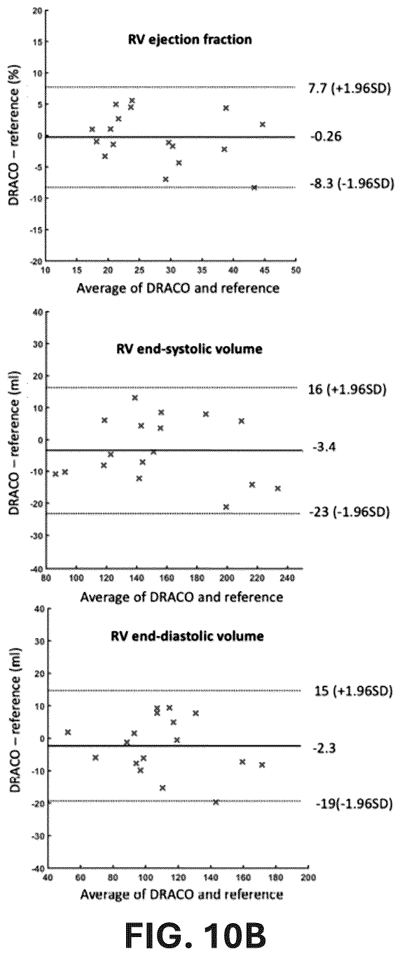

Paired t-tests found no significant difference between metrics of cardiac function derived from the DRACO method and real-time method (Table 4). Bland-Altman analyses of DRACO and real-time derived EF, ventricular volumes, biventricular mass in arrhythmia subjects showed clinically negligible mean bias values (FIGS. 10A-10B, Table 4). A total of 94% of data points were within the 95% limits of agreement. In the 17 subjects, LV EF was 30.1%±9.71% (DRACO) versus 28.9%±9.58% (reference), and RV EF was 27.7%±8.31% (DRACO) versus 27.9%±9.42% (reference).

TABLE 4
Comparison of cardiac functional metrics derived from
DRACO relative to reference real-time cine MRI

| Parameter | Mean bias* | 95% confidence interval** | P** |
|---|---|---|---|
| LV EF (%) | 1.2 | [−1.2, 3.6] | 0.30 |
| LV EDV (mL) | −3.5 | [−9.5, 2.4] | 0.22 |
| LV ESV (mL) | −3.8 | [−8.4, 0.8] | 0.10 |
| LV mass (g) | 2.5 | [−3.9, 8.9] | 0.43 |
| RV EF (%) | −0.26 | [−2.4, 1.8] | 0.80 |
| RV EDV (mL) | −3.4 | [−8.6, 1.7] | 0.18 |
| RV ESV (mL) | −2.3 | [−6.8, 2.2] | 0.29 |

*Mean bias and 95% confidence intervals are derived from Bland-Altman analyses.
**Group comparisons using paired t-tests with corresponding 95% confidence intervals.
EF, ejection fraction; EDV, end-diastolic volume; ESV, end-systolic volume; g, grams; LV, left ventricular; mL, milliliters; RV, right ventricular

While the disclosure has been particularly shown and described with reference to specific embodiments (some of which are preferred embodiments), it should be understood by those having skill in the art that various changes in form and detail can be made therein without departing from the spirit and scope of the present disclosure as disclosed herein.

What is claimed is:

1. A computer-implemented method of reconstructing images of a motion of a region of interest (ROI) of a subject, the method comprising:
(a) receiving, by a processor via an imaging modality, image data and navigator data corresponding the motion of the ROI of the subject over a predefined duration;
(b) determining, by the processor, a cluster matrix of the ROI using a clustering model applied the navigator data,
wherein the cluster matrix of the ROI indicates, for each time frame within the predefined duration and for each cluster of a plurality of clusters, a probability that the motion captured by the navigation data is associated with a corresponding cluster; and
(c) reconstructing, by the processor, the images of the motion of the ROI over the predefined duration by weighing and combining the image data based on the cluster matrix for the ROI.

2. The computer-implemented method of claim 1, wherein the ROI over the predefined duration exhibits irregular and non-periodic motion.

3. The computer-implemented method of claim 1 or 2, wherein the image data and the navigator data are acquired by the imaging modality based on a golden step pulse sequence.

4. The computer-implemented method of any one of claims 1-3, wherein the determining the cluster matrix of the ROI comprises:
(i) identifying the plurality of clusters based on the navigator data; and
(ii) dynamically updating the plurality of clusters.

5. The computer-implemented method of claim 4, wherein the dynamically updating the plurality of clusters enforces temporal continuity between adjacent time frames.

6. The computer-implemented method of any one of claims 1-5, further comprising, prior to the reconstructing: regularizing, by the processor, using the cluster matrix of the ROI, a similarity between at least two clusters of the plurality of clusters.

7. The computer-implemented method of claim 6, wherein the regularizing the similarity enforces similarity between adjacent clusters.

8. The computer-implemented method of any one of claims 1-7, further comprising: determining a sensitivity map based on the image data, wherein the reconstructing is further based on the sensitivity map.

9. The computer-implemented method of any one of claims 1-8, wherein the reconstructing comprises: applying a regularization along a temporal dimension of the image data using the cluster matrix of the ROI.

10. The computer-implemented method of claim 9, wherein the regularization along the temporal dimension comprises total variation regularization.

11. The computer-implemented method of any one of claims 1-10, wherein the image data includes one or more unresolved areas of the ROI, wherein the reconstructing comprises: determining, using the cluster matrix of the ROI, an order and a weighting for each of the one or more unresolved areas of the ROI.

12. The computer-implemented method of any one of claims 1-11, wherein the receiving the image data and the navigator data comprises: acquiring the image data from the subject via the imaging modality while the patient is freely breathing.

13. The computer-implemented method of any one of claims 1-12, wherein the cluster matrix comprises non-binary values representing partial association with the plurality of clusters.

14. The computer-implemented method of any one of claims 1-13, wherein the image modality comprises at least one of magnetic resonance imaging (MRI), computed tomography (CT), ultrasound, or positron emission tomography (PET).

15. The computer-implemented method of any one of claims 1-14, wherein the ROI comprises cardiac tissue.

16. The computer-implemented method of claim 15, wherein the imaging modality is MRI, and wherein the navigator data is acquired without reliance on electrocardiogram (ECG) gating.

17. The computer-implemented method of any one of claims 1-17, wherein the images of the motion of the ROI are cardiac imaging, lung imaging, abdominal imaging, gastrointestinal (GI) imaging, fetal imaging, or oropharyngeal imaging.

18. A system for reconstructing images of a motion of a ROI of a subject, the system comprising:
a memory storing computer readable instructions, and
one or more processors coupled to the memory and configured to perform operations comprising:
(a) receiving, by the one or more processors via an imaging modality, image data and navigator data corresponding to the motion of the ROI of the subject over a predefined duration;
(b) determining, by the one or more processors, a cluster matrix of the ROI using a clustering model applied to the navigator data,
wherein the cluster matrix of the ROI indicates, for each time frame within the predefined duration and for each cluster of a plurality of clusters, a probability that the motion captured by the navigation data is associated with a corresponding cluster; and
(c) reconstructing, by the one or more processors, the images of the motion of the ROI over the predefined duration by weighing and combining the image data based on the cluster matrix for the ROI.

19. The system of claim 18, wherein the ROI over the predefined duration exhibits irregular and non-periodic motion.

20. The system of claim 18 or 19, wherein the image data and the navigator data are acquired by the imaging modality based on a golden step pulse sequence.

21. The system of any one of claims 18-20, wherein the determining the cluster matrix of the ROI comprises:
(i) identifying the plurality of clusters based on the navigator data; and
(ii) dynamically updating the plurality of clusters.

22. The system of claim 21, wherein the dynamically updating the plurality of clusters enforces temporal continuity between adjacent time frames.

23. The system of any one of claims 18-22, further comprising, prior to the reconstructing: regularizing, by the processor, using the cluster matrix of the ROI, a similarity between at least two clusters of the plurality of clusters.

24. The system of claim 23, wherein the regularizing the similarity enforces similarity between adjacent clusters.

25. The system of any one of claims 18-24, further comprising: determining a sensitivity map based on the image data, wherein the reconstructing is further based on the sensitivity map.

26. The system of any one of claims 18-25, wherein the reconstructing comprises: applying a regularization along a temporal dimension of the image data using the cluster matrix of the ROI.

27. The system of claim 26, wherein the regularization along the temporal dimension comprises total variation regularization.

28. The system of any one of claims 18-27, wherein the image data includes one or more unresolved areas of the ROI, wherein the reconstructing comprises: determining, using the cluster matrix of the ROI, an order and a weighting for each of the one or more unresolved areas of the ROI.

29. The system of any one of claims 18-28, wherein the receiving the image data and the navigator data comprises: acquiring the image data from the subject via the imaging modality while the patient is freely breathing.

30. The system of any one of claims 18-29, wherein the cluster matrix comprises non-binary values representing partial association with the plurality of clusters.

31. The system of any one of claims 18-30, wherein the image modality comprises at least one of magnetic resonance imaging (MRI), computed tomography, ultrasound, or positron emission tomography.

32. The system of any one of claims 18-31, wherein the ROI comprises cardiac tissue.

33. The system of claim 32, wherein the imaging modality is MRI, and wherein the navigator data is acquired without reliance on electrocardiogram (ECG) gating.

34. The system of any one of claims 18-33, wherein the images of the motion of the ROI are cardiac imaging, lung imaging, abdominal imaging, gastrointestinal (GI) imaging, fetal imaging, or oropharyngeal imaging.

35. A non-transitory computer-readable medium storing instructions that, when executed by a processor, cause to perform operations comprising:
(a) receiving, by the one or more processors via an imaging modality, image data and navigator data corresponding to a motion of a ROI of a subject over a predefined duration;
(b) determining, by the one or more processors, a cluster matrix of the ROI using a clustering model applied to the navigator data,
wherein the cluster matrix of the ROI indicates, for each time frame within the predefined duration and for each cluster of a plurality of clusters, a probability that the motion captured by the navigation data is associated with a corresponding cluster; and
(c) reconstructing, by the one or more processors, the images of the motion of the ROI over the predefined duration by weighing and combining the image data based on the cluster matrix for the ROI.
